(19) United States
(12) Patent Application Publication
(10) Pub. No.: US 2022/0404618 A1
(43) Pub. Date: Dec. 22, 2022

(54) DISPLAY SYSTEMS USING LIGHT EXTRACTION CONFIGURATIONS FOR MICRO LIGHT EMITTING DIODES

(71) Applicant: Raxium, Inc., Fremont, CA (US)

(72) Inventors: Michael Anthony Klug, Austin, TX (US); Bradley Jay Sissom, Boulder, CO (US)

(21) Appl. No.: 17/831,817

(22) Filed: Jun. 3, 2022

Related U.S. Application Data
(60) Provisional application No. 63/254,967, filed on Oct. 12, 2021.
(60) Provisional application No. 63/213,566, filed on Jun. 22, 2021.
(60) Provisional application No. 63/213,574, filed on Jun. 22, 2021.

(51) Int. Cl. G02B 27/01; G02B 3/00; G02B 13/16

(52) U.S. Cl. CPC G02B 27/0101; G02B 3/0056; G02B 13/16

(57) ABSTRACT

A display system is disclosed including an emitter system assembly for providing a light output. The emitter system assembly includes a first emitter that provides a first emission spectrum, a cavity at least partially surrounding the first emitter, a first aperture configured for transmitting therethrough at least a portion of the first emission spectrum from the first emitter, and a shaping element in optical communication with the first aperture. The cavity includes reflectors that reflect the first emission spectrum within the cavity and toward the aperture.

### RELATED APPLICATIONS

This application claims the benefit of priority of U. S. Provisional Patent Application Nos. 63/254,967 filed Oct. 12, 2021, 63/213,566 filed Jun. 22, 2021, and 63/213,574 filed Jun. 22, 2021. The entire contents of each of the aforementioned applications is incorporated herein by reference.

### BACKGROUND

Aspects of the present disclosure generally relate to light emitting diodes (LEDs), and more specifically, to assemblies that enhance light extraction from micro light emitting diodes (microLEDs).

Recent advances in light emitting diode (LED) technologies have enabled the formation of high density display devices incorporating arrays of microLEDs, with each microLED having an emitter pitch on the order of a few microns to a fraction of a micron. For example, Appendix A discloses various configurations of microLED-based light field displays.

To illustrate the contrast between conventional and micro-LED-based displays, FIG. 1 shows a conventional display 110 having an array 120 of light emitting elements 125, as better seen in an inset 130. Light emitting elements 125, which may be traditional LEDs as discussed above, may all emit light at the same wavelength, or be arranged in patterns of LEDs emitting at two or more wavelengths. For example, array 120 may include LEDs emitting at red, green, and blue wavelengths in the visible spectrum, and arranged in a regular pattern.

In the example shown in FIG. 1, light emitting elements 125 may be arranged in a Q×P array over the area of display 110, with Q being the number of rows of light emitting elements 125 in the array and P being the number of columns of light emitting elements 125 in the array. Though not shown, conventional display 110 may include, in addition to light emitting elements 125, a backplane that includes various electrical traces and contacts configured to selectively deliver power to one or more of light emitting elements 125.

FIG. 2 shows a light field display 210 having an array 220 of super-raxels 225, as shown in a first inset 230. Further, each super-raxel 225, as shown in a second inset 240, includes sub-raxels 245. Each one of sub-raxels 245 may be a microLED, as described above. That is, each super-raxel 225 may correspond in size with a light emitting element 125 of FIG. 1, while including a plurality of sub-raxels 245 formed of microLEDs with emitter pitch of a few microns or even a fraction of a micron. In the example shown in FIG. 2, each super-raxel 225 is shown as having a generally square shape with each side having a super-raxel pitch 227. Each super-raxel 225 may be configured for emitting light at a single wavelength range (e.g., a red, green, or blue wavelength range) or over a range of colors (e.g., over at least a portion of the visible electromagnetic wavelength range).

In the example shown in FIG. 2, super-raxels 225 are arranged an N×M array, with N being the number of rows of super-raxels 225 in the array and M being the number of columns of super-raxels 225 in the array. As shown in FIG. 2, each one of super-raxels 225 includes a plurality of sub-raxels 245. Each one of sub-raxels 245 may include a microLED emitting at red, green, or blue wavelength in the visible spectrum, for example, and arranged in a regular pattern. In an example, sub-raxels 245 of different colors may be monolithically integrated on a common substrate, and each one of the microLEDs in a sub-raxel 245 may range in size from a fraction of 1 micron to approximately 100 microns.

FIG. 3 shows the light steering aspects of super-raxels 225. As shown in inset 330, each one of super-raxels 225 may include a light steering optical element 340 for steering light emitted from that super-raxel 225 to a desired location. In the example illustrated in FIG. 3, each light steering optical element 340 is shown as having a lens pitch 345 on the order of the size of one of super-raxel 225.

While microLED-based displays enable new applications, various improvements are still possible to maximize the performance of each microLED and the display as a whole. In particular, compact microLED arrays for augmented reality/virtual reality (AR/VR) and other near-eye display applications require high brightness light output with highly efficient light extraction.

### SUMMARY OF THE DISCLOSURE

The following presents a simplified summary of one or more aspects in order to provide a basic understanding of such aspects. This summary is not an extensive overview of all contemplated aspects and is intended to neither identify key or critical elements of all aspects nor delineate the scope of any or all aspects. Its purpose is to present some concepts of one or more aspects in a simplified form as a prelude to the more detailed description that is presented later.

In an aspect of the disclosure, a display system is disclosed, wherein the display system includes an emitter system assembly for providing a light output. The emitter system assembly includes a first emitter that provides a first emission spectrum, a cavity at least partially surrounding the first emitter, and a first aperture configured for transmitting therethrough at least a portion of the first emission spectrum from the first emitter. The emitter system assembly further includes a shaping element in optical communication with the first aperture, wherein the cavity includes reflectors that reflect the first emission spectrum within the cavity and toward the aperture.

In another aspect of the disclosure, an emitter array system comprising is disclosed. The emitter array system includes a center emitter configured to provide a center emission spectrum, a peripheral emitter configured to provide a peripheral emission spectrum, a center cavity at least partially surrounding the center emitter, and a peripheral cavity at least partially surrounding the peripheral emitter. The emitter array system further includes a center aperture configured for transmitting therethrough at least a portion of the center emission spectrum from the center emitter, a peripheral aperture configured for transmitting therethrough at least a portion of the peripheral emission spectrum from the peripheral emitter, a center shaping element in optical communication with the center aperture, wherein the center shaping element directs the center emission spectrum at a first angle, and a peripheral shaping element in optical communication with the peripheral aperture, wherein the peripheral shaping element directs the peripheral emission spectrum at a second angle.

### BRIEF DESCRIPTION OF THE DRAWINGS

The appended drawings illustrate only some implementation and are therefore not to be considered limiting of scope.

FIG. 1 illustrates an example of a display having multiple pixels, in accordance with aspects of this disclosure.

FIGS. 2 and 3 illustrate examples of a light field display having multiple picture elements, in accordance with aspects of this disclosure.

FIG. 4 illustrates a general configuration for light extraction from an LED, in accordance with aspects of this disclosure.

FIGS. 5-7 illustrate examples of light extraction configurations, in accordance with aspects of this disclosure.

FIGS. 8-10 illustrate examples of configurations for light extraction from an array of microLEDs, in accordance with aspects of this disclosure.

FIG. 11 shows a flow chart illustrating a process for forming light extraction configurations for microLEDs, in accordance with aspects of this disclosure.

FIG. 12 shows a top schematic view of a near-eye display system, in accordance with aspects of this disclosure.

FIGS. 13-15 show top schematic views of emitter array systems having lenslets, gratings, and prisms, respectively, in accordance with aspects of this disclosure.

FIGS. 16A-16B illustrate front views of emitter array systems, in accordance with aspects of this disclosure.

FIG. 16C illustrates a perspective view of an emitter array system, in accordance with aspects of this disclosure.

FIG. 17 illustrates a top schematic view of a near-eye display system, in accordance with aspects of this disclosure.

FIG. 18A-18B illustrate a front and perspective view, respectively, of an emitter array system, in accordance with aspects of this disclosure.

FIG. 19 illustrates a top schematic view of an emitter array system, in accordance with aspects of this disclosure.

FIG. 20 illustrates a top schematic view of a near-eye display system, in accordance with aspects of this disclosure.

FIGS. 21A-21B show top schematic views of emitter array systems having light absorbing elements, in accordance with aspects of this disclosure.

FIGS. 22A-22B show top schematic views of emitter array systems having a parallax barrier and shutters, respectively, in accordance with aspects of this disclosure.

FIGS. 22C-22D illustrate top schematic views of a near-eye display system having a movable shutter, in accordance with aspects of this disclosure.

FIG. 23 shows a top schematic view and two detailed views of a uniform telecentric near-eye display, in accordance with aspects of this disclosure.

FIG. 24 illustrates a top schematic view of an optical system having a uniform chief ray skew configuration, in accordance with aspects of this disclosure.

FIG. 25 illustrates a top schematic view of an optical system having a hyper telecentric chief ray skew configuration, in accordance with aspects of this disclosure.

FIG. 26 illustrates a front view of an emitter array system having a hyper telecentric chief ray skew configuration, in accordance with aspects of this disclosure.

FIG. 27 illustrates a top schematic view of a near-eye display system having a hyper telecentric chief ray skew configuration, in accordance with aspects of this disclosure.

FIG. 28 illustrates a top schematic view of an optical system having a convergent chief ray skew configuration, in accordance with aspects of this disclosure.

FIG. 29 illustrates a front view of an emitter array system having a convergent chief ray skew configuration, in accordance with aspects of this disclosure.

FIG. 30 illustrates a top schematic view of a near-eye display system having a convergent chief ray skew configuration, in accordance with aspects of this disclosure.

FIGS. 31A-31B show partial top schematic views of an emitter array system having non-uniform diffraction structures, in accordance with aspects of this disclosure.

FIGS. 32A and 32B illustrate perspective schematic view of optical systems having display systems and waveguides, in accordance with aspects of this disclosure.

FIGS. 33A and 33B illustrate front and top views, respectively, of an emitter array panel, in accordance with aspects of this disclosure.

FIGS. 33C and 33D illustrate front and top views, respectively, of an emitter array panel, in accordance with aspects of this disclosure.

FIGS. 34A and 34B illustrate center and peripheral detailed views of an emitter array panel, in accordance with aspects of this disclosure.

FIGS. 34C and 34D illustrate embodiments of an emitter array panel, in accordance with aspects of this disclosure.

FIG. 35 illustrates an example of an elongated projector lens, in accordance with aspects of this disclosure.

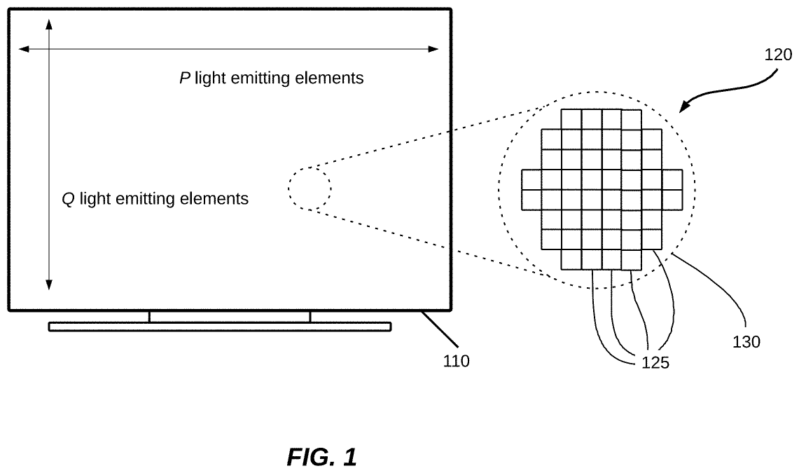

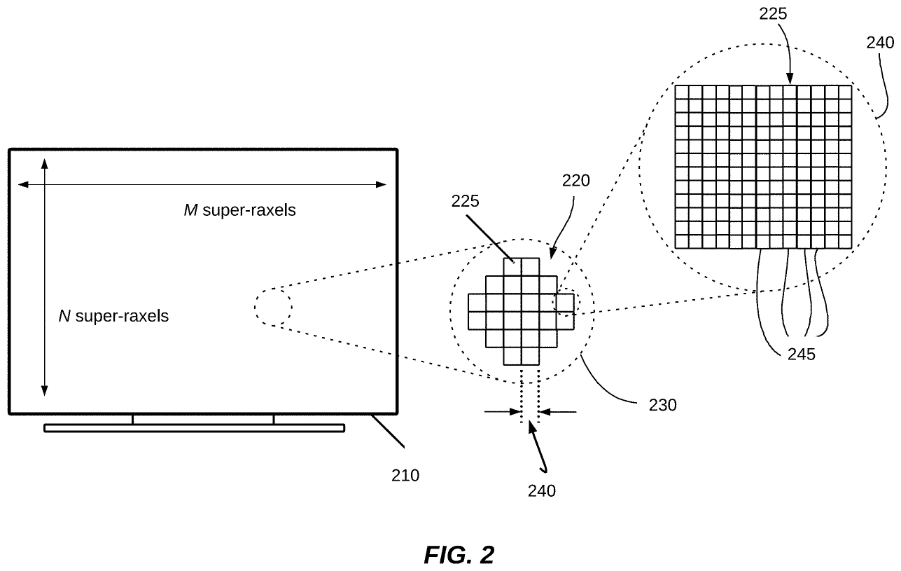

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts.

In order to effectively take advantage of the small size and high efficiency of microLEDs, as much of the light produced by each microLED should be extracted as possible. Accordingly, new configurations are desirable for improved extraction of light produced by microLEDs.

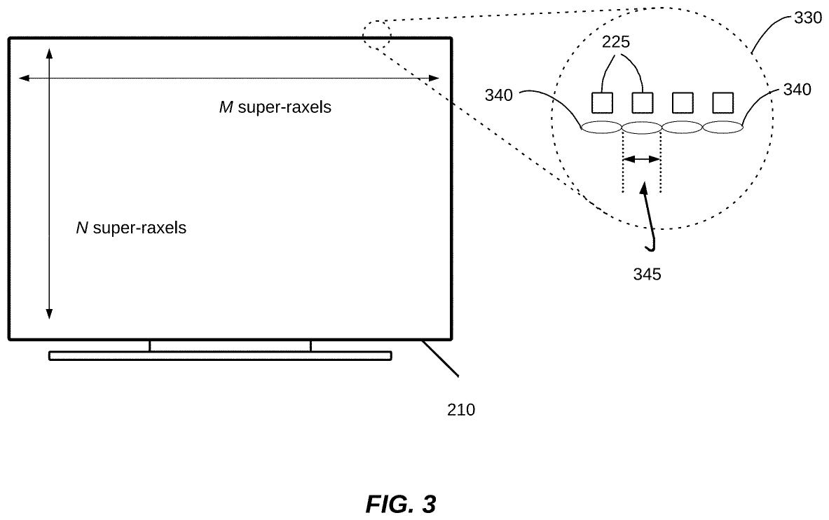

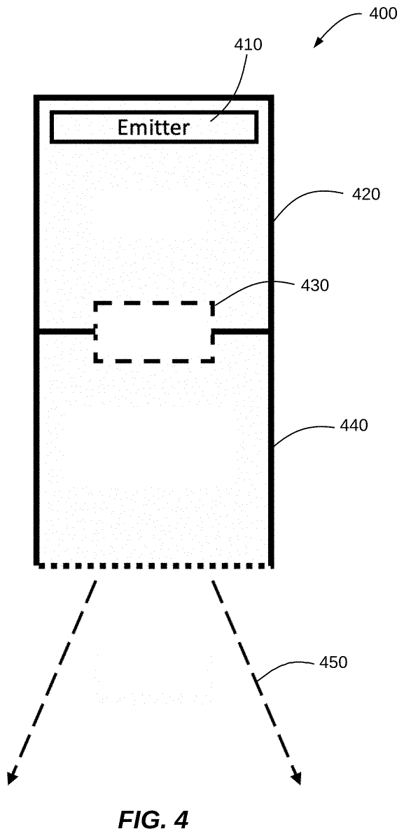

FIG. 4 shows an exemplary configuration for improved light extraction from a light emitter such as microLEDs. As shown in FIG. 4, an emitter system 400 includes an emitter 410 for generating light emission. For instance, emitter 410 may be a conventional LED or microLED based on quantum well (QW) technology, or another type of small light emitter. Emitter 410 is surrounded by an LED cavity 420. An etendue gate 430 provides a spatial aperture for light from emitter 410 to be released toward mode matching optics 440. Mode matching optics 440 is configured for shaping light from LED cavity 420 into an output 450 that matches the requirements of a specific application, such as for use in a projector device.

More specifically, LED cavity 420 may include, for example, high reflectivity surfaces for containing the light produced by emitter 410. The geometry of LED cavity 420 may be tailored for specific applications to provide an optimal geometry for optical coupling through etendue gate 430. It is noted that, although called a “cavity,” LED cavity 420 may be filled with a material other than air, such as a solid semiconductor (such as gallium nitride) or another material (such as an insulator) that is substantially transmissive to the light emitted by emitter 410.

Etendue gate 430 may be a fixed or adjustable spatial aperture for efficiently coupling light out of LED cavity 420 with mode matching optics 440. Etendue gate 430 may further include, for example, a filter for selectively transmitting light with specific characteristics therethrough, such as light incident at etendue gate 430 within a specific range of incident angles, polarization state, wavelength, resonant cavity mode, and other optical characteristics. For instance, etendue gate 430 may include one or more non-reflective, low-reflective, or anti-reflective layer for enhancing display contrast in the presence of external light. As an example, an array of emitter systems 400 may be formed into a display, each emitter system producing light contributing to an image produced by the display. In such a display, if there is external light introduced into the display, each etendue gate 430 may reflect the external light so as to detract from the image produced by the display. Such undesirable effects may be reduced by incorporating one or more non-reflective, low-reflective, or anti-reflective layer at etendue gate 430 such that any external light reaching etendue gate 430 may be integrated into LED cavity 420.

Mode matching optics 440 may include one or more refractive, reflective, or diffractive optics arranged in an imaging or non-imaging configuration. Mode matching optics 440 may be tailored for providing output 450 matching the acceptance light field of the specific application. For instance, if emitter system 400 is intended for providing light emission for use in a projector, such as for augmented reality (AR) or virtual reality (VR) headsets, then mode matching optics 440 may be configured for converting light transmitted through etendue gate 430 into output 450 that optimally matches the acceptance criteria for the projector. Again, non-reflective, low-reflective, or anti-reflective layers may be incorporated into mode matching optics 440 to reduce the effects of external light being introduced into emitter system 400.

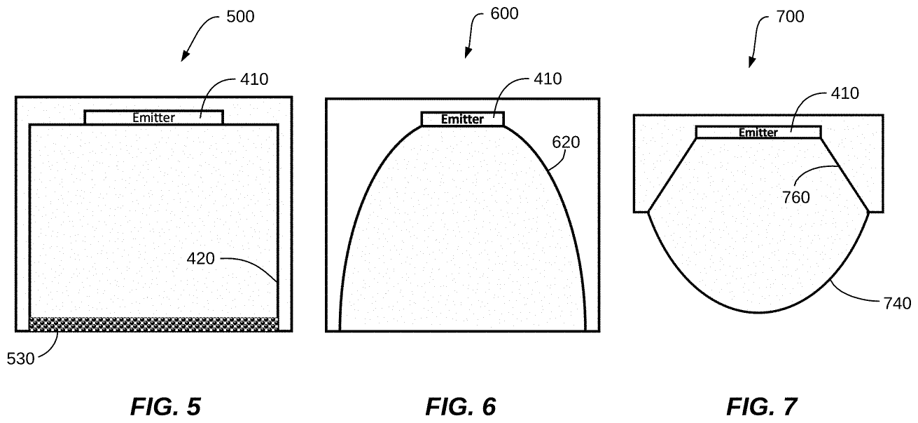

In an alternative embodiment, as shown in FIG. 5, etendue gate 430 and mode matching optics 440 for an emitter system 500 may be replaced by a textured surface 530 for diffusing the light emitted from emitter 410. In this case, LED cavity 420 may be configured for efficiently directing light emitted from emitter 410 toward the textured surface, to provide light output suitable for use in applications that does not require a collimated light output.

In certain cases, with the appropriate design for mode matching optics 440, LED cavity 420 may be reduced or eliminated. For example, as shown in FIG. 6, an emitter system 600 may include emitter 410 positioned at the peak of a truncated compound parabolic curve (CPC) collimator 620 serving as mode matching optics 440. In the case of emitter system 600, truncated CPC collimator 620 may provide sufficient mode matching and shaped light output for certain applications. Alternatively, as shown in FIG. 7, an aspherical lens 740 may be used as mode matching optics 440 formed adjacent to emitter 410. Aspherical lens 740 may include shaped sidewalls 760 such that, with an appropriate design of shaped sidewalls 760, aspherical lens 740 alone, without a cavity, can provide a suitably shaped light output for certain applications.

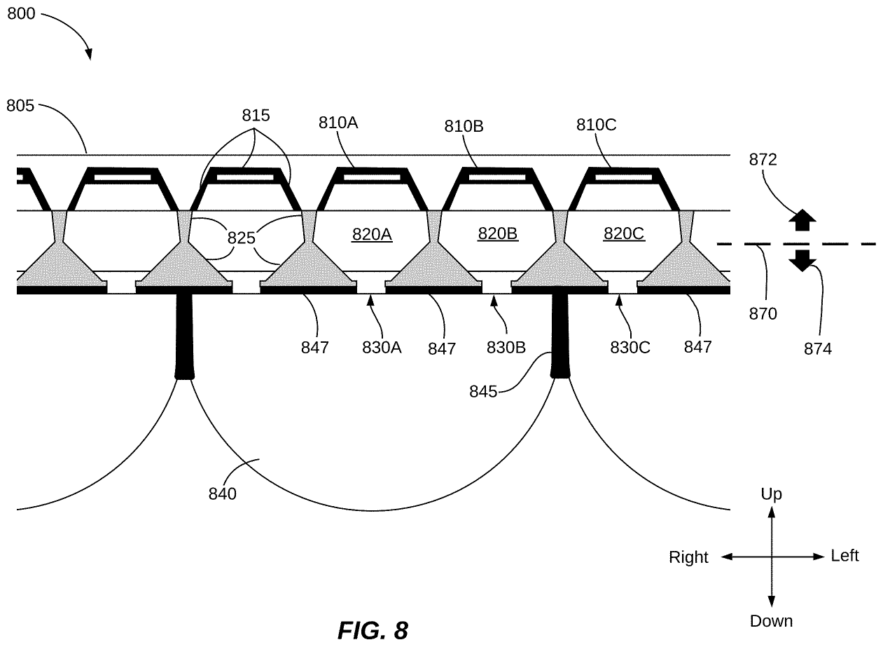

FIG. 8 shows a cross-sectional view of an emitter array system 800 including light extraction features, in accordance with an embodiment. Emitter array system 800 includes an LED substrate 805 supporting several emitters 810A, 810B, and 810C arranged in a two-dimensional array, for example. As an example, emitters 810A may be quantum well-based microLEDs configured for emitting light in a red wavelength range, emitters 810B may be microLEDs configured for emitting light in a green wavelength range, and emitters 810C may be microLEDs configured for emitting light in a blue wavelength range. In another configuration, emitters 810A, 810B, and/or 810C may be configured to emit light in the same wavelength range. In an example, each one of emitters 810A, 810B, and 810C is surrounded by reflective surfaces 815 such that light emitted by that emitter is directed downward in FIG. 8. Reflective surfaces 815 may be formed of a metal (e.g., aluminum, gold, silver), a dielectric, a multi-layer film stack of dielectric materials, or any combination thereof.

Continuing to refer to FIG. 8, emitter array system 800 further includes LED cavities 820A, 820B, and 820C, adjacent to emitters 810A, 810B, and 810C, respectively. LED cavities 820A, 820B, and 820C may be formed, for example, with a semiconductor (such as GaN) or other material (such as an insulator or a transparent conductive oxide) compatible with light transmission in the desired wavelengths. LED cavities 820A, 820B, and 820C include reflective surfaces 825 therein for containing and/or shaping light emitted from emitters 810A, 810B, and 810C, respectively. Reflective surfaces 825 may also be formed of a metal (e.g., aluminum, gold, silver), a dielectric, a multi-layer film stack of dielectric materials, or any combination thereof. For example, LED cavity 820A may be defined by a cavity geometry optimized for coupling light emitted by emitter 810A to an aperture 830A, LED cavity 820B may be optimized for coupling light emitted by emitter 810B to an aperture 830B, and LED cavity 820C may be formed to be best compatible with light emitted by emitter 810C to be coupled to an aperture 830C. In another example, two or more of LED cavities 820A, 820B, and 820C may be identical to each other. Similarly, apertures 830A may be distinct from apertures 830B and/or 830C, or apertures 830A, 830B, and 830C may be identical in dimensions. Apertures 830A, 830B, and 830C, in an example, may be formed conjugate with the plane of an input coupling grating (ICG), such as those serving as an input port of a waveguide for near-eye display glasses. Other types of throughput-limiting aperture configurations may be implemented according to the requirements of the mode coupling optics or other downstream optics from the apertures. Further, optionally, apertures 830A, 830B, and/or 830C may including additional optical properties, such as angular, wavelength, and/or polarization filtering capabilities.

Light emanating from LED cavities 820A, 820B, and 820C through apertures 830A, 830B, and 830C, respectively, is directed through lenslets 840 in the example illustrated in FIG. 8. Each one of lenslets 840 corresponds to mode matching optics 440 of FIG. 4. In the example shown in FIG. 8, each lenslet 840 is configured for directing light from multiple emitters 810A, 810B, and 810C. Each one of lenslets 840 may be formed, for example, directly on the backplane, or a lenslet array may be formed separately then attached to the backplane after formation of the apertures and absorber coatings.

Each one of lenslets 840 may be separated from each other one of lenslets 840 by light baffle absorbers 845. For instance, light baffle absorbers 845 may be configured for reducing crosstalk between adjacent lenslets 840. Additionally, areas between apertures 830A, 830B, and 830C may be covered by an absorber material 847 for further reducing stray light traveling through lenslets 840. In an example embodiment, a line 870 represents a demarcation, above which the formation of emitters 810A, 810B, and 810C, reflectors 815, part of LED cavities 820A, 820B, and 820C, and reflector 825 may be formed as part of the microLED fabrication (as indicated by an arrow 872). Below line 870, the various components may be formed during processing performed after microLED fabrication has been completed and the emitters and LED cavity portions have been bonded to a backplane wafer (as indicated by an arrow 874).

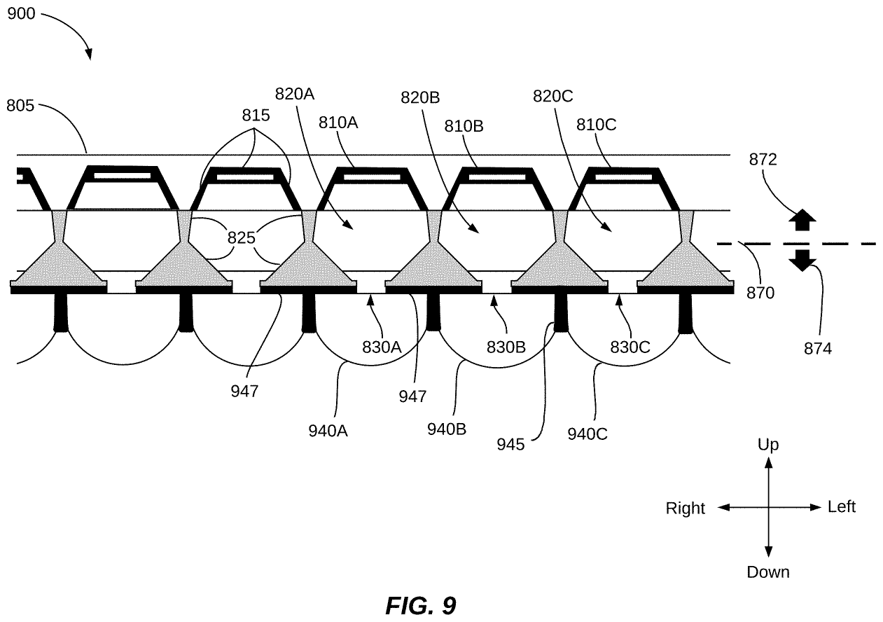

FIG. 9 shows an emitter array system 900, in accordance with an embodiment. Emitter array system 900 includes the same microLED fabrication side components as emitter array system 800 of FIG. 8. However, each one of apertures 830A, 830B, and 830C is coupled with its own lenslet 940A, 940B, and 940C, respectively. Adjacent lenslets 940A, 940B, and 940C are separated by light baffle absorbers 945, and areas between apertures 830A, 830B, and 830C may be covered by an absorber material 947. In this configuration, each one of lenslets 940A, 940B, and 940C may be configured for coupling with the specific wavelength and other light characteristics of the light emitted by the corresponding one of emitters 810A, 810B, and 810C.

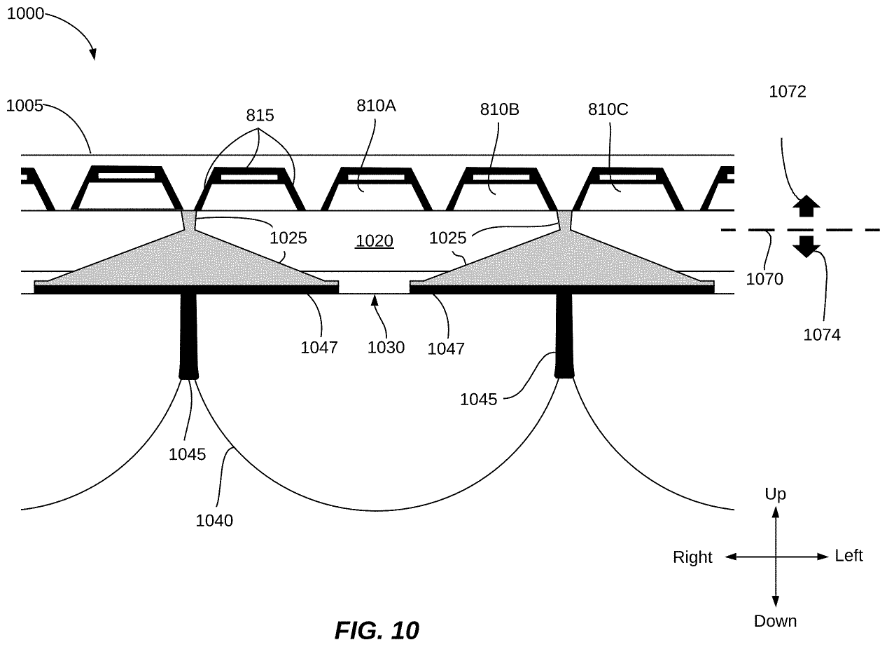

FIG. 10 shows an emitter array system 1000, in accordance with an embodiment. Emitter array system 1000 includes an LED substrate 1005 supporting the same emitters 810A, 810B, and 810C with reflectors 815, as illustrated in FIG. 8. In contrast to emitter array system 800 of FIG. 8, emitter array system 1000 includes one LED cavity 1020 for a group of emitters 810A, 810B, and 810C. The geometry of LED cavity 1020 and the properties of reflector 1025 may be tailored for optimum coupling of light emitted from emitters 810A, 810B, and 810C to an aperture 1030 and into a lenslet 1040. In an example, lenslet 1040 may be identical to lenslet 840 of FIG. 8. Adjacent lenslets 1040 may be separated by light baffle absorbers 1045, and areas between apertures 1030 may be coated with an absorber material 1047.

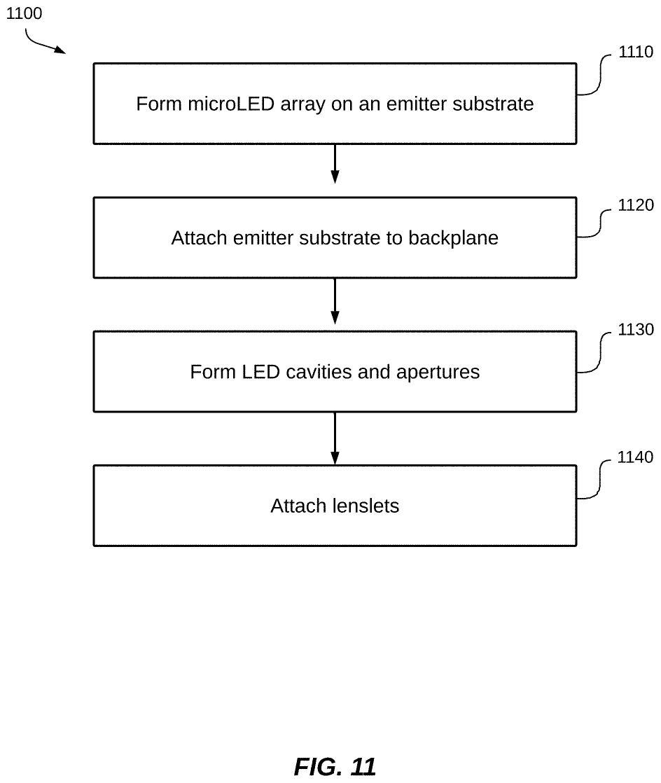

FIG. 11 shows an exemplary process for forming the emitter array systems disclosed above, in according to an embodiment. A process 1100 begins with a step 1110 of forming an emitter array on an emitter substrate. Step 1110 may include, in reference to FIG. 8, forming emitters 810A, 810B, and 810C supported on or within substrate 805, forming reflectors 815 surrounding emitters 810A, 810B, and 810C, and forming the microLED-side of LED cavities 820A, 820B, and 820C as well as portions of reflectors 825.

Process 1100 proceeds to a step 1120 to attach the emitter array to a backplane, then a step 1130 to form the rest of the LED cavities and apertures. For instance, the emitter array may be attached to the backplane, after which the emitter substrate, supporting the emitter array, may be removed. Finally, process 1100 proceeds to a step 1140 to attach the lenslets to form the structures illustrated, for example, in FIGS. 8-10.

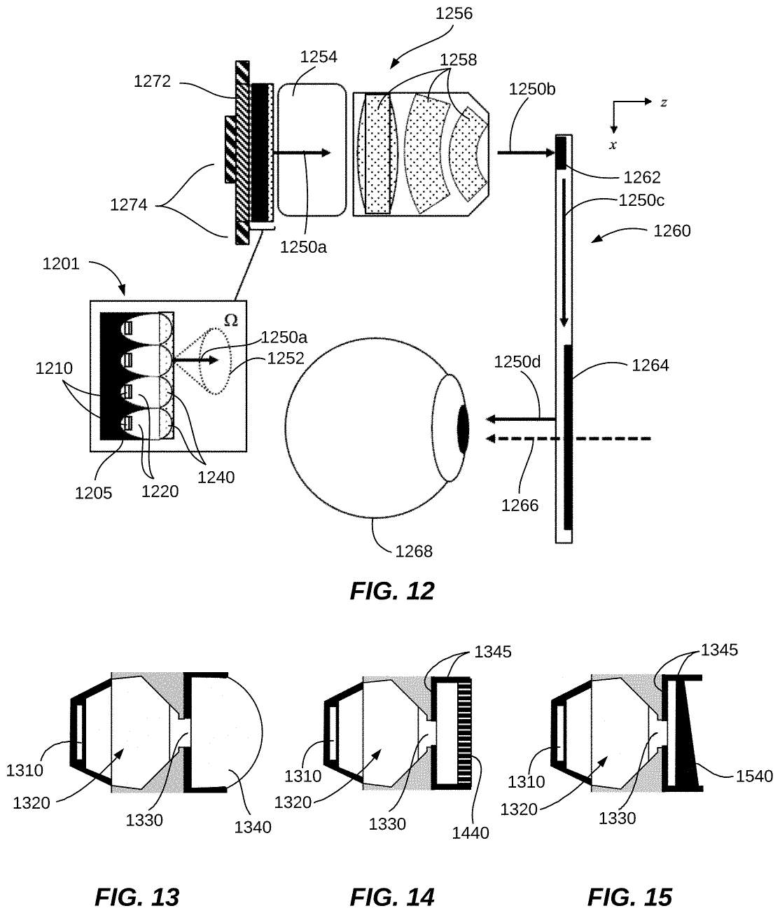

An emitter array system as discussed above may be included within a variety of optical and display systems. For example, FIG. 12 illustrates a top-down view of a near-eye display system 1200 having an emitter array system 1201 as shown in the detailed view in the left inset square. The emitter array system 1201 includes a plurality of emitters 1210 (e.g., microLEDs) disposed on or in an LED substrate 1205. The system 1201 further includes a plurality of cavities 1220 similar to cavities 820 discussed above with respect to FIG. 8 and configured to receive light from the emitters 1210. A plurality of lenslets 1240, or other optics, may be disposed over the cavities 1220 such that light emitted by the emitters 1220 exits the emitter array system 1201 as a light beam 1250a. The beam 1250a is shaped as a cone 1252 defined by an angle, Ω, between outermost rays of the beam. The emitter array system 1201 may be coupled with one or more back end components such as a backplane display bed 1272 and/or backplane drivers and buffers 1274.

The light beam 1250a emitted from the emitter array system 1201 may travel through an interface region 1254 between the emitter array system 1201 and a projection lens 1256. The interface region 1254 may be an air gap or a layer of material having a selected index of refraction as a matter of design choice. Once the light reaches projection lens 1256, a plurality of optical elements 1258 disposed therein may shape the light and output a beam 1250b toward an incoupling element 1262 disposed on or in one or more waveguide 1260. The incoupling element 1262 may redirect a portion of the light from beam 1250b such that the portion of light 1250c travels within the waveguide 1260 (e.g., via total internal reflection) until it reaches an outcoupling element 1264. The outcoupling element 1264 redirects a portion of the light 1250c such that it exits the waveguide 1260 as light 1250d toward a user's eye 1268. Thus, light emitted by the light emitting array 1201 is relayed through a near-eye display system and is visible to a user. Additionally, if the waveguide 1260 is transparent, the user may also see world light 1266 that passes therethrough. Thus, world light and at least a portion of light from the emitter array system (e.g., an augmented reality view) can be presented to the user. The system 1200 may benefit from improved light extraction provided by the cavities adjacent the emitters, as discussed above.

While FIG. 12 shows that lenslets 1240 may be used to shape light emitted by the emitters 1210, other configurations are possible. FIGS. 13-15 illustrate alternative options for shaping light that is generated by emitter 1310 and is passed through a cavity 1320 and aperture 1330. FIG. 13 illustrates a lenslet 1340 surrounded on the sides by a light baffle absorber 1345. Additional light absorbing material may be placed between the base of the lenslet 1340 and the cavity 1320 with an opening to allow light through the aperture 1330. The absorber material may help prevent cross-talk between adjacent lenslets. FIGS. 14 and 15 illustrate that the lenslet 1340 can be replaced with a diffractive element 1440 (e.g., a diffractive or a metamaterials lens) or a prism 1540. The lenslet 1340, diffractive element 1440, and/or prism 1540 may be used to focus and/or redirect light from the emitters 1310. Each of the configurations shown in FIGS. 12-15 illustrate a one-to-one relationship between an emitter and a cavity and an emitter and a light shaping element (e.g., lenslet, diffractive element, prism, metalens); however, light from multiple emitters may be shaped by a single light shaping element as will be discussed below.

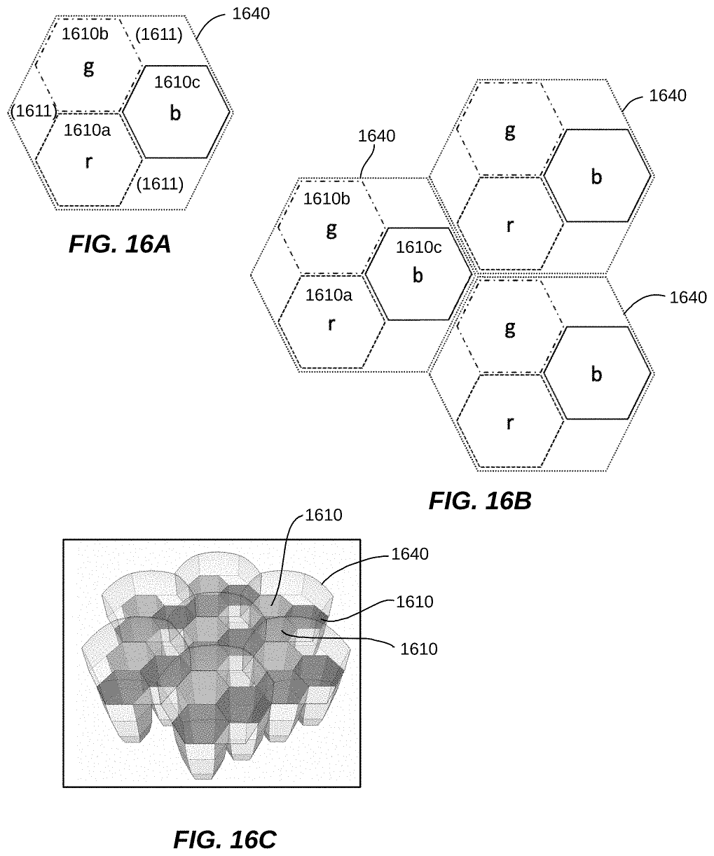

Referring to FIG. 16A, light emitting elements 1610a-c are shown arranged in a hexagonal packing configuration with intermittent gaps 1611 to accommodate a hexagonal packing configuration of lenslets 1640, as will be discussed below. The light emitting elements 1610 may each emit light having the same or a different wavelength. For example, all light emitting elements 1610a-c may emit the same color light; alternatively, 1610a may emit a first color light (e.g., red light), 1610b may emit a second color light (e.g., green light), and 1610c may emit a third color light (e.g., blue light). While the elements 1610 are shown as hexagons, they may be any shape including circles, squares, or other shapes as a matter of design choice.

Multiple light emitting elements 1610a-c may be covered by a single lenslet 1640 as shown. The lenslet 1640 may be truncated (e.g., from a circular shape) around the perimeter in order to form a hexagonal footprint. As illustrated in the front and perspective views of FIGS. 16B and 16C, respectively, hexagonal lenslets advantageously allow for adjacent lenslets to be nested into a hexagonal packing configuration similar to the light emitting elements 1610a-c. While other lenslet shapes may be selected as a matter of design choice, hexagons may allow for the largest lenslets and/or the most densely packed lenslet arrangement. Additionally, while three light emitting elements are shown under each lenslet, more or fewer elements per lenslet may be used.

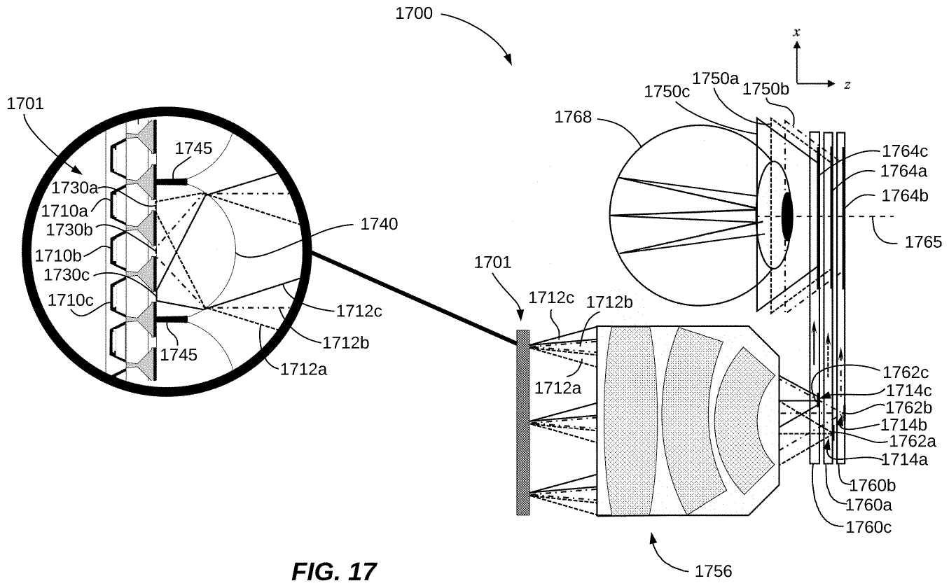

Referring to FIG. 17, a top-down view of a near-eye display system 1700 is shown. A detailed view of an emitter array system 1701 is illustrated within the left circle. The emitter array system 1701 includes a plurality of light emitting elements 1710a-c configured to direct light through a respective aperture 1730a-c to a single lenslet 1740. Light absorbers or baffles 1745 may be disposed between adjacent lenslets 1740. Lenslet 1740 may be a spherical, aspherical, cylindrical, or other profile lenslet. Light from each emitter is directed differently depending on the position of the light emitting element relative to the lenslet 1740. For example, light from emitter 1710a (e.g., light cone illustrated with dotted lines) is directed at a downward angle by the lenslet 1740 and exits the system 1701 as first beam 1712a at a first angle. Light from emitter 1710b (e.g., light cone illustrated with dot-dashed lines) may be centered with respect to the lenslet 1740 and exits the system 1701 as second beam 1712b at a second angle (e.g., perpendicular to a flat back surface of the lenslet 1740). Light from emitter 1710c (e.g., light cone illustrated with solid lines) is directed at an upward angle by the lenslet 1740 and exits the system 1701 as third beam 1712c at a third angle. While light paths from three emitters 1710a-c are described, the array 1701 extends in the x- and y-directions and many light beams may exit the array in substantially the same way as described above with respect to beams 1712a-c. In some embodiments, the light emitting elements may be arranged such that all light having a first wavelength exits the array system at the first angle, all light having a second wavelength exits the array system at the second angle, and all light having a third wavelength exits the array system at the third angle as shown in the system view of FIG. 17 on the right.

Light from each of the activated emitters 1710 within the emitter array system 1701 travels through its respective aperture and lenslet where beams are angled before exiting the emitter array system toward a projection lens 1756 as shown. Light beams 1712a entering the projection lens 1756 at the first angle (e.g., beams represented by dotted lines) may all carry the same first color light (e.g., red light). The beams 1712a pass through the projection lens 1756 and form a first light pupil at a first location 1714a having a center at a first coordinate location (x₁, y₁, z₁). Similarly, the beams 1712b and 1712c (e.g., beams represented by dot-dashed and solid lines, respectively) pass through the projection lens 1756 and are focused at second and third locations 1714b, 1714c, respectively. The second and third locations have second and third coordinate locations (x₂, y₂, z₂) and (x₃, y₃, z₃), respectively. Thus, light exiting the projection lens 1756 may be spatially separated by color.

A plurality of waveguides 1760a-c may be configured to receive the spatially separated light beams. For example, a first waveguide 1760a may be placed such that an incoupling element 1762a thereon is positioned at or near the first coordinate location (x₁, y₁, z₁). Light having the first wavelength is incoupled to the first waveguide by the first incoupling element into the first waveguide where it may travel by total internal reflection (“TIR”) through the waveguide toward a first outcoupling element 1764a. Similarly, second and third waveguides 1760b, 1760c may be positioned such that second and third incoupling elements 1762b, 1762c on second a third waveguides 1760b, 1760c are located at or near the second and third coordinate locations (x₂, y₂, z₂) and (x₃, y₃, z₃), respectively. Light having the second and third wavelengths are incoupled into the second a third waveguides, respectively, where they travel by TIR toward second and third outcoupling elements 1764b, 1764c. First, second, and third outcoupling elements 1764a-c may be substantially aligned relative to a viewing axis 1765 such that all wavelengths of light are outcoupled in substantially the same location. First, second, and third outcoupled beams are represented as light cones 1750a-c and may substantially overlap such that a user's eye 1768 receives light of all different wavelengths. Thus, the user may perceive a full color image.

Spatially separating input light by color before incoupling light into the different waveguides may allow for each waveguide, incoupling element, and outcoupling element to be designed for each specific wavelength of light. Thus, the overall optical system may produce a higher quality image (e.g., brighter, sharper, more uniform, fewer artifacts) and may be more power efficient compared to systems incoupling a wide range of wavelengths into a single waveguide. While the system has been discussed with respect to three wavelengths, more or fewer wavelengths of light may be spatially separated by adjusting the arrangement of the emitter array relative to the lenslet array.

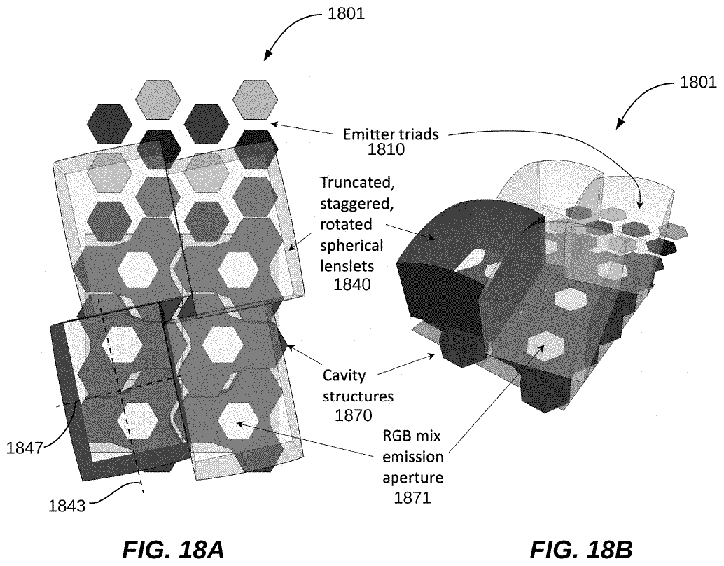

FIGS. 18A-B illustrate front and perspective views of an emitter array system 1801. The light emitting elements 1810 within the emitter array system 1801 may be arranged in a hexagonal packing configuration similar to that discussed with respect to FIG. 16, however, the emitter array system 1801 may not have gaps between emitters 1810. Between the light emitting elements 1810 and lenslets 1840 is a cavity structure 1870. The cavity structure 1870 may be formed from an opaque material configured to cover and surround a plurality (e.g., a triad) of emitters (e.g., a red, green, and blue emitter). The cavity structure 1870 includes an aperture 1871 that may be located at a position near the center of the plurality of emitters such that a substantially equal portion of light emitted by each of the emitters 1810 passes through the aperture 1871. Light from the plurality of emitters is combined at the aperture 1871 and, in some embodiments, white light or different colors of light depending on emitter activation may be created at the output of the aperture. The aperture 1871 is shown as hexagonal, however other shapes, such as circles, may be used as a matter of design choice. The opaque material forming the cavity structures may be a bi-layer of reflective material internally and absorptive material externally (e.g., to reduce scatter and crosstalk). A variety of materials may be used including metallic, carbon-based, and dielectric materials.

A plurality of lenslets 1840 are disposed on the cavities and are configured to receive light emitted through the aperture 1871. As shown in FIG. 18A, each lenslet 1840 may receive light through two adjacent apertures 1871. The lenslets 1840 are truncated (e.g., from a circular shape) spherical lenslets that are arranged in an array such that each of the two apertures align on a first axis 1843 bisecting the lenslet 1840 and such that each of the two apertures are equally distant from a second axis 1847 bisecting the lenslet 1840 in a direction orthogonal to the first axis. The intersection of first and second axes may be the apex of the spherical lenslet.

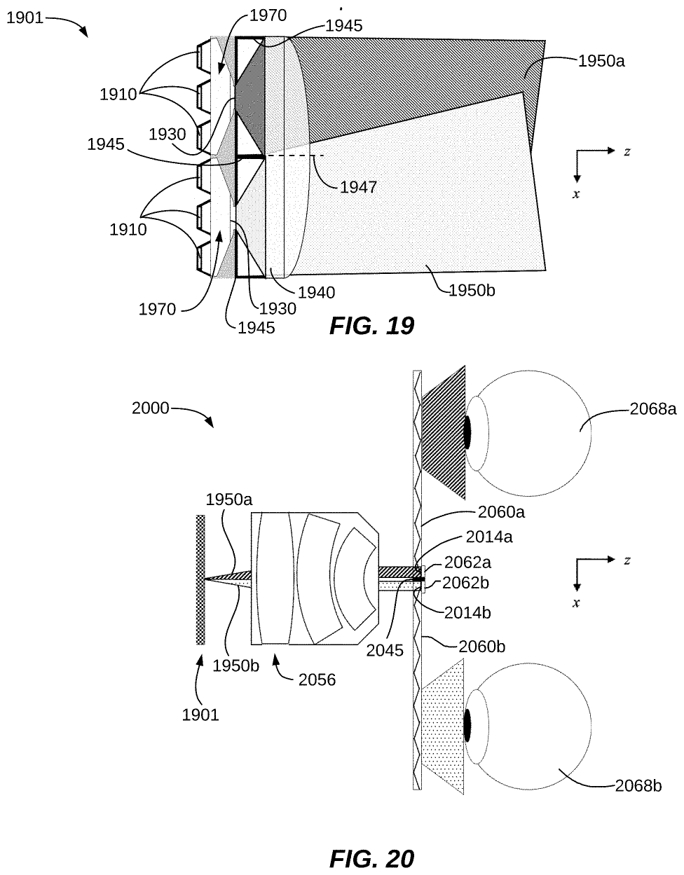

FIG. 19 illustrates a top cross-sectional view of the emitter array system 1901 having a structure similar to the emitter array system 1801. The system 1901 includes emitters 1910, cavity structures 1970, apertures 1930 and a lenslet 1940. Light baffle absorbers 1945 may be disposed between the apertures 1930 and the lenslet 1940 to reduce cross-talk between a first and second beam of light 1950a, 1950b exiting the two apertures. Apertures 1930 may be equally distant from an axis 1947 of the lenslet 1940 and may be offset relative to the apex of the lenslet. Such a position allows for the first beam of light 1950a from the first aperture to be directed at a first angle and the second beam of light 1950b from the second aperture to be directed at a second angle after interacting with the lenslet 1940. Thus, system 1901 may spatially separate light from adjacent light emitting element groups. Such a system may have advantages as illustrated in FIG. 20. A near-eye display system 2000 is shown having an emitter array system 1901 as illustrated in FIG. 19. First and second beams 1950a, 1950b from a single lenslet are illustrated while light from other lenslets in the array are omitted from the figure for clarity. The beams 1950a, 1950b travel toward a projection lens 2056 which forms first and second pupils at first and second locations 2014a, 2014b, respectively. The first and second locations are laterally offset in the x-direction. A first and second waveguide 2060a, 2060b having first and second incoupling elements 2062a, 2062b may be positioned such that the first and second incoupling elements are configured to receive the first and second beams, respectively. Light from the first beam 1950a is incoupled into the first waveguide and travels (e.g., by TIR) toward an outcoupling element where it is extracted from the waveguide and directed toward a user's right eye 2068a. Similarly, light from the second beam 1950b is incoupled into the second waveguide and travels (e.g., by TIR) toward an outcoupling element where it is extracted from the waveguide and directed toward a user's left eye 2068b. Thus, by actuating one group of light emitting elements per lenslet to display right image light and by actuating the other group of light emitting elements associated with the same lenslet to display left image light, the system 1901 can generate separate left and right images simultaneously. The left and right images may be the same or different images. A light absorber 2045 may be disposed between the first and second waveguides to prevent light from the first beam from reaching the second waveguide and vice versa.

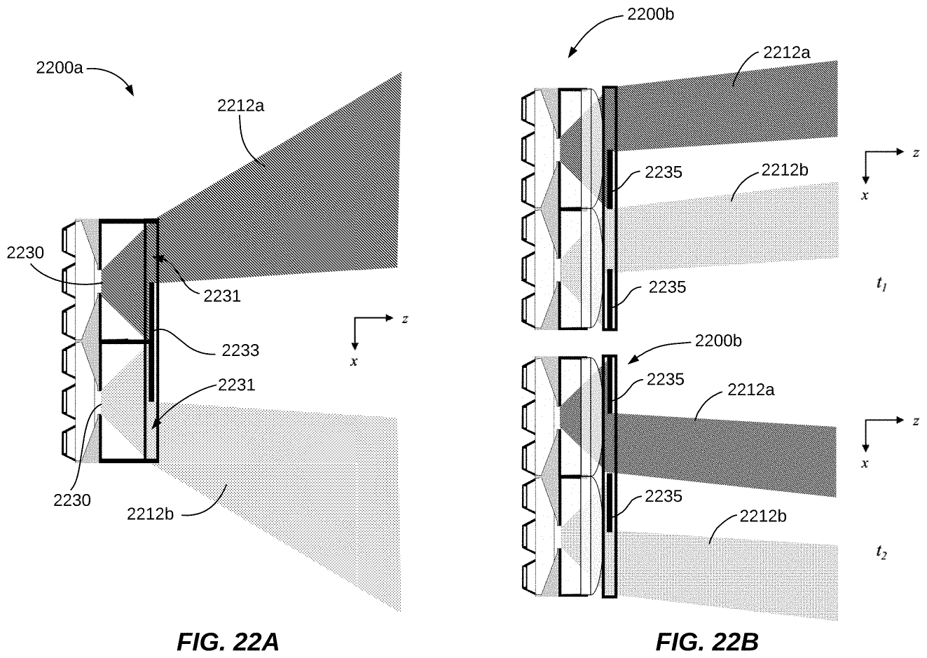

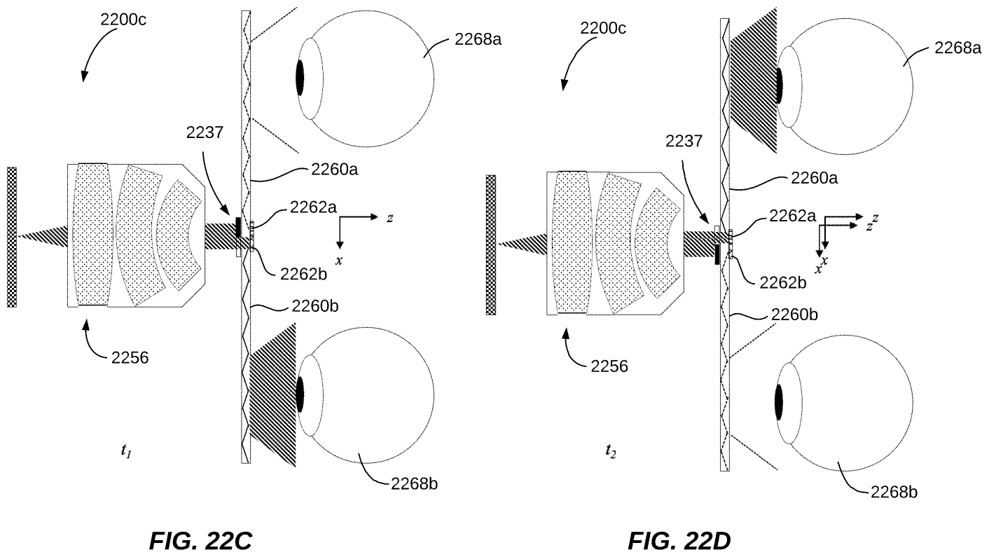

Creating two different images (e.g., one for a left eye and one for a right eye) may be important in creating augmented reality (“AR”) near-eye display systems. In some systems, different images are created by using two separate emitter array and projection lens assemblies. This approach increases size, weight, and cost of the overall system. Alternatively, if only a single emitter array and projection lens assembly is used (e.g., using a system as will be discussed below with reference to FIGS. 22C, 22D), the emitter array may alternate between projecting light for a left image and light for a right image. Since only half of the generated light is directed to each eye, this approach may result in a perceived reduction in system frame rate. The emitter array system 1901 provides space saving benefits. Even though twice as many emitter groups are used to generate the two separate images, the arrangement of light emitting elements in a hexagonal packing configuration allows more densely packed emitters (e.g., compared to an orthogonal grid) such that the overall area is less than 2× larger despite containing twice the number of emitter groups. Furthermore, because each emitter group is dedicated to generating light for only one of the two separate images, the frame rate of the system is not reduced. A single backplane and driver electronics set may reduce power consumption of the system. Minimal additional processing may be required to assemble the left and right interleaved images.

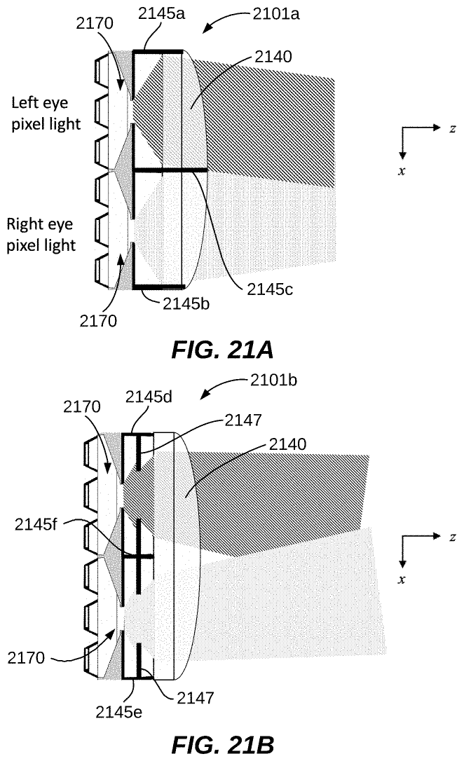

FIGS. 21A and 21B illustrate top-down cross-sectional views of emitter array systems 2101a, 2101b, respectively. The systems 2101a, 2101b are similar to the system 1901 illustrated in FIG. 19, however different cross-talk mitigation configurations are implemented. In FIG. 21A, perimeter absorbers 2145a, 2145b extend from the top of the cavity structure 2170 and cover the side of lenslet 2140. A center absorber 2145c extends from the top of the cavity structure 2170 through the lenslet 2140 to its apex. The center absorber 2145c prevents light from a first beam from traveling through the lens to outcouple with the second beam and vice versa. In FIG. 21B, perimeter absorbers 2145d, 2145e and center absorber 2145f extend from the top of the cavity structure 2170 to a bottom of the lenslet 2140. Additional absorbers 2147 may be substantially perpendicular to the perimeter absorbers 2145d-f and may act as apertures to narrow the first and second beams such that the beams are further separated as they pass through the lenslet 2140. This second aperture may help limit cross-talk between the two light beams. The variations illustrated in FIGS. 21A and 21B may be combined and other buffers and light absorbers may be placed around or within the cavity structures and lenslets to maintain separation between the first and second beams. Additionally, while spherical lenslets are described in this configuration, cylindrical lenses may be used in this and other configurations described in the present disclosure. Use of cylindrical lenses may advantageously reduce or eliminate diffraction that occurs in spherical lenslets; however, cylindrical lenses may also result in loss of concentration of light in one micro display axis.

FIGS. 22A and 22B illustrate optical systems 2200a and 2200b, respectively, that do not rely on lenslets to spatially separate light beams. Rather, in both systems an aperture 2231 is used to sample emission cones generated by the emitters 2210 such that light from neighboring emitter groups (or single emitters in some configurations) is centered on opposing input angles to the downstream projection lens (not shown). By omitting lenslets, the systems 2200a, 2200b may benefit from reduced artifacts that occur due to TIR reflections within lenslets, reduced edge scatter, and reduced diffraction.

System 2200a in FIG. 22A includes a parallax barrier 2233 between two adjacent cavity apertures 2230. The parallax barrier 2233 may serve to block a portion of each of light beams 2212a, 2212b such that the portion of light that passes through the apertures 2231 is angled. In some embodiments, approximately half of each of the light beams 2212a, 2212b is blocked by the parallax barrier 2233. This spatial separation of light may be used to simultaneously create two different images (e.g., a first image for a left eye and a second image for a right eye).

System 2200b in FIG. 22B includes liquid crystal or otherwise movable physical barrier MEMS shutters 2235 to selectively block portions of beams 2212a, 2212b. In the top panel, at a first time, first portions of light beams 2212a, 2212b are blocked by shutters 2235; in the bottom panel, at a second time, second portions of light beams 2212a, 2212b are blocked by shutters 2235. The portion of light blocked may alternate so that light is alternatingly directed in opposing angles. This temporal and spatial separation may be used to create two different image (e.g., a first image for a left eye and a second image for a right eye).

FIGS. 22C and 22D illustrate a system 2200c that includes a movable or otherwise dynamic shutter 2237 in front of incoupling elements 2262a, 2262b on waveguides 2260a, 2260b. The shutter 2237 may include liquid crystal or movable MEMS shutters. At a first time, shown in FIG. 22C, the shutter 2237 may be at a first position such that a first portion of the light projected by projection lens 2256 is blocked while a second portion of the light transmits therethrough and impinges on the second incoupling element 2262b. The second portion of light incouples to the second waveguide 2260b and propagates through the waveguide by TIR before being outcoupled toward a user's left eye 2268b. At a second time, shown in FIG. 22D, the shutter 2237 is moved to a second position such that the second portion of the light projected by the projection lens is blocked while the first portion of the light transmits through the open shutter and impinges on the first incoupling element 2262a. The first portion of light incouples into the first waveguide 2260a and propagates through the waveguide by TIR before being outcoupled toward the user's right eye 2268a. Thus, light from the projector lens 2256 may be spatially and temporally modulated to create two different images. The movable shutter configuration illustrated in FIGS. 22C-D may be used in combination with emitter array systems illustrated in FIGS. 21A-B and 22A-B.

In addition to spatially modulating output beams by uniformly positioning light emitting elements relative to a lenslet, a diffractive element, a prism, a metalens, a parallax barrier, or a shutter, the location of a light pupil exiting a projection lens may be gradually varied by carrying the angle of light exiting an emitter array system as a function of distance from the center of the array. Adjusting the angle at which light is emitted by the emitter array system may result in a changing the location of a pupil formed by a projection lens. In some embodiments, the change in location of the pupil results in changing a working distance (i.e., a distance between a projector lens output bezel and the focal point of the light) of the projection lens. In other embodiments, the change in emission angle of light from the emitter array may result in lateral shifting of the pupil formed by a projection lens.

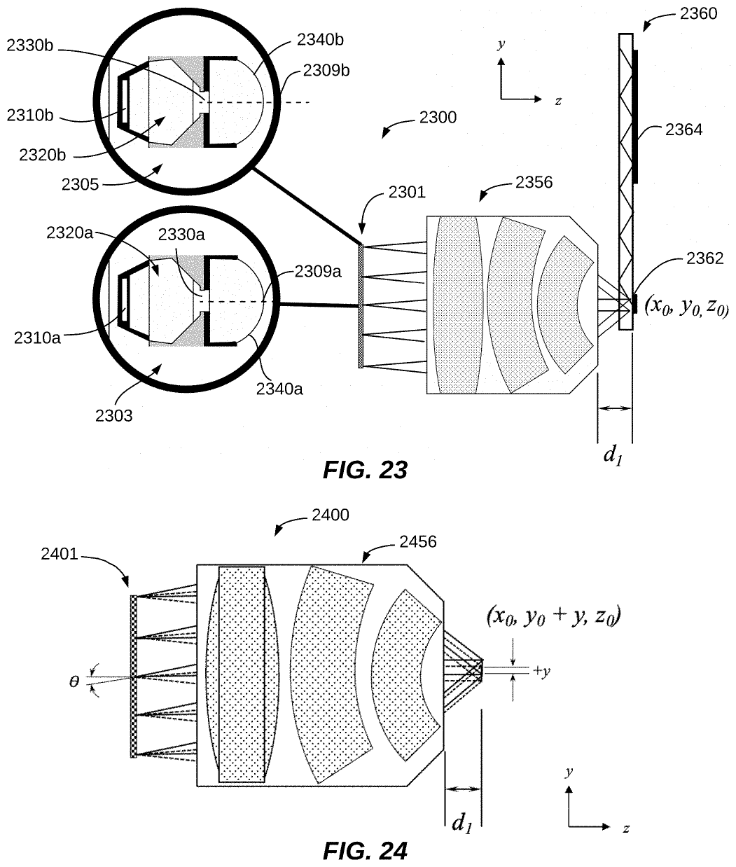

Referring to FIG. 23, a near-eye display system 2300 is illustrated. The system 2300 includes an emitter array system 2301, a projection lens 2356, and a waveguide 2360 having an incoupling element 2362 and an outcoupling element 2364. The working distance, d₁, is illustrated between the bezel of the projector lens and the focal point of the emitted light.

A first detailed view of a center portion 2303 of the emitter array system 2301 is illustrated in the bottom circle in FIG. 23. The center emitter 2310a and associated aperture 2330a of the cavity 2320a are aligned with the axis of symmetry 2309a of center lenslet 2340a. Thus, light emitted from the emitter 2310a through the aperture 2330a and through lenslet 2340a has a chief ray directed along the axis 2309a of lenslet 2340a. A second detailed view of a peripheral portion 2305 of the emitter array system 2301 is illustrated in the top circle. The peripheral emitter 2310b and associated aperture 2330b of the cavity 2320b are also aligned with the axis of symmetry 2309b of the peripheral lenslet 2340b in the same way that the center emitter is aligned. All emitters and lenslets in the array system 2301 from the center to the periphery are aligned in the same way such that all light emissions cones from the system 2301 are uniform and have chief rays that are substantially parallel to each other. All of the chief rays are also substantially perpendicular to the emitter array system panel. This configuration is considered a telecentric emission configuration and results in the working distance d₁ and a pupil centered at coordinate location (x₀, y₀, z₀) as shown.

FIG. 24 illustrates an optical system 2400 having a uniform chief ray skew across the emitter array system 2401. Cones of light illustrated in dotted lines are uniform telecentric emissions as discussed with respect to FIG. 23 and serve as a reference for the chief ray skew configuration illustrated in solid lines. By uniformly changing the angle (e.g., by an angle θ in the y-z-plane) of each light emission cone across the full emitter array system 2401, the pupil location of light exiting the projector lens 2456 can be adjusted in the +y direction as shown. Such uniform angle shift can be achieved by laterally shifting the entire lenslet array relative to the emitter aperture array. Thus, with cones of light entering the projector lens 2456 at angle θ, the coordinate location of the exit pupil from the projector lens is (x₀, y₀+y, z₀). While the angle θ is shown in the y-z-plane, the input angle of light into the projector lens may be adjusted in the x-z-plane to affect the x location of the pupil or may be adjusted in both the x-z- and y-z-planes simultaneously to affect both the x and y locations of the exit pupil.

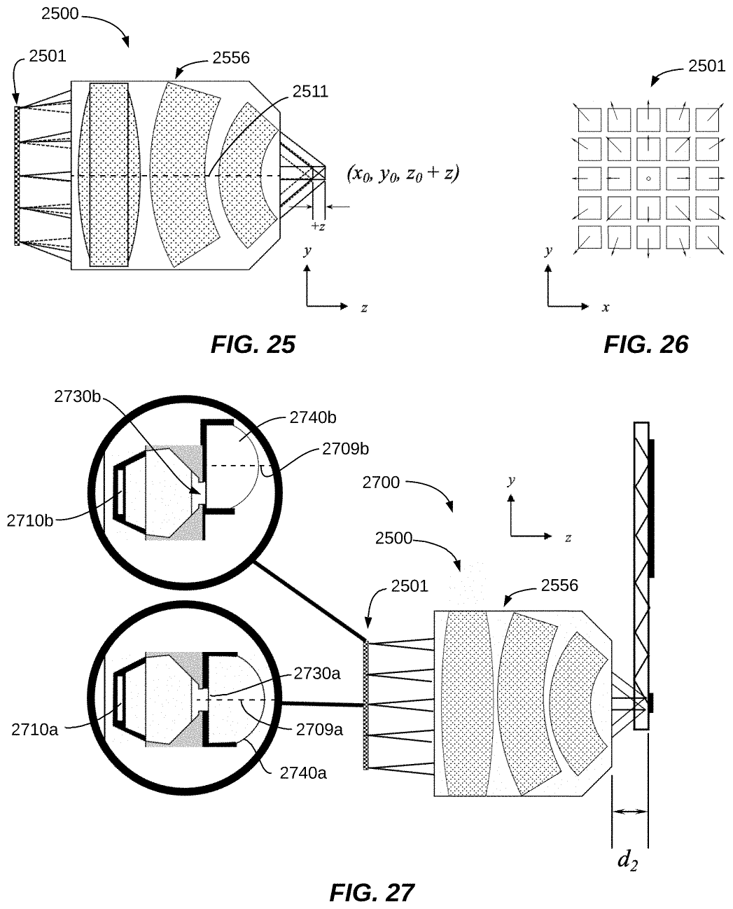

Adjusting a location of an exit pupil in the +/−z-direction has the effect of changing the working distance of an optical system. It is advantageous to be able to customize a working distance to fit certain form factors or other geometric constraints within an optical system. FIG. 25 illustrates a hyper telecentric optical system 2500 having an emitter array system 2501 and a projection lens 2556. The system is considered hyper telecentric because chief rays of the emitted cones of light illustrated by solid lines (where dotted lines represent uniform telecentric cones for reference) are substantially normal to the emitter array panel at the center of the emitter array panel and gradually increase in angle away from a centerline 2511 of the projector 2556 with increasing distance from the center of the emitter array panel. This concept is schematically illustrated in FIG. 26 which shows a front view of the emitter array system 2501. The lenslet array in the emitter array system emits light having chief rays that are directed substantially out of the page at the center of the array and emits light having chief rays that are most skewed away from the center of the emitter array system 2501 at the periphery of the array. Thus, the angle of the chief ray in the emitted light cone is a function of the (x, y) location of the emitter within the emitter array system 2501. The maximum chief ray angle (i.e., the chief ray angles at the periphery of the emitter array system) may determine the magnitude of the pupil location change in the +z direction. In some embodiments, there may exist a sufficiently large chief ray angle where the projector lens size must be increased in order to capture all light from the emitter array system to minimize vignetting at the edges of the image.

Referring back to FIG. 25, the pupil formed at the exit of the projector lens 2556 is moved in the +z direction compared to the uniform telecentric case and has a coordinate location of (x₀, y₀, z₀+z). FIG. 27 shows a near-eye display system 2700 including the optical system 2500 described above. The system 2700 further includes a waveguide 2760 having an incoupling element 2762 and an outcoupling element 2764. Because the pupil formed at the exit of the projection lens 2556 is at coordinate location (x₀, y₀, z₀+z), where z is a positive number, the working distance d₂ between the projection lens exit and the pupil is greater than the working distance d₁ for the uniform telecentric configuration (FIG. 23). Thus, the incoupling element 2762 configured to receive the pupil and incouple light to the waveguide 2760 may be placed further away from the exit of the projection lens 2556 when compared to the near-eye display system 2300 having a uniform telecentric emitter array system 2301.

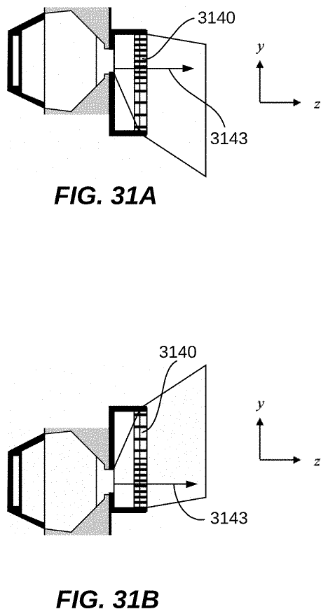

Varied angles of chief rays across the emitter array 2501 may be achieved by varying the relative position between emitters and lenslets. For example, a center aperture 2730a and center emitter 2710a may be aligned with a center axis 2709a of the center lenslet 2740a as shown in the detailed view in the bottom left circle. The position between the emitters and lenslets at the periphery of the emitter array 2501 may be different. For example, as shown in the detailed view in the top circle of FIG. 27, a peripheral aperture 2730b and peripheral emitter 2710b may be offset by a distance relative to the center axis 2709b of the peripheral lenslet 2740b such that the center of the lenslet 2740b is closer to a periphery of the array system than the center of the emitter 2710b. When light from the peripheral emitter 2710b passes through the offset peripheral lenslet 2740b, it is redirected such that the chief ray of the light cone has an angle directed away from the center of the emitter array system 2501. The offset between emitters and lenslets may be incrementally increased with increasing distance from the center of the emitter array system 2501 to achieve a change in the +z direction of the pupil location. While a single emitter per lenslet is shown, configurations with groups of emitters per lenslet are also possible as described with respect to FIGS. 16-22. The focal length and the surface profile of the lenslets can determine the concentration of light within the emitted solid angle omega. Additionally, while lenslets 2740 are illustrated, gratings, meta-lenses, prisms or other micro-optics may be incorporated to alter the chief ray angles. An example of an off-axis diffraction structure 3140 is shown in FIGS. 31A and 31B where the pitch of the diffractive structure 3140 is non-uniform and diffracts the cone of light such that a chief ray is angled with respect to a normal vector 3143.

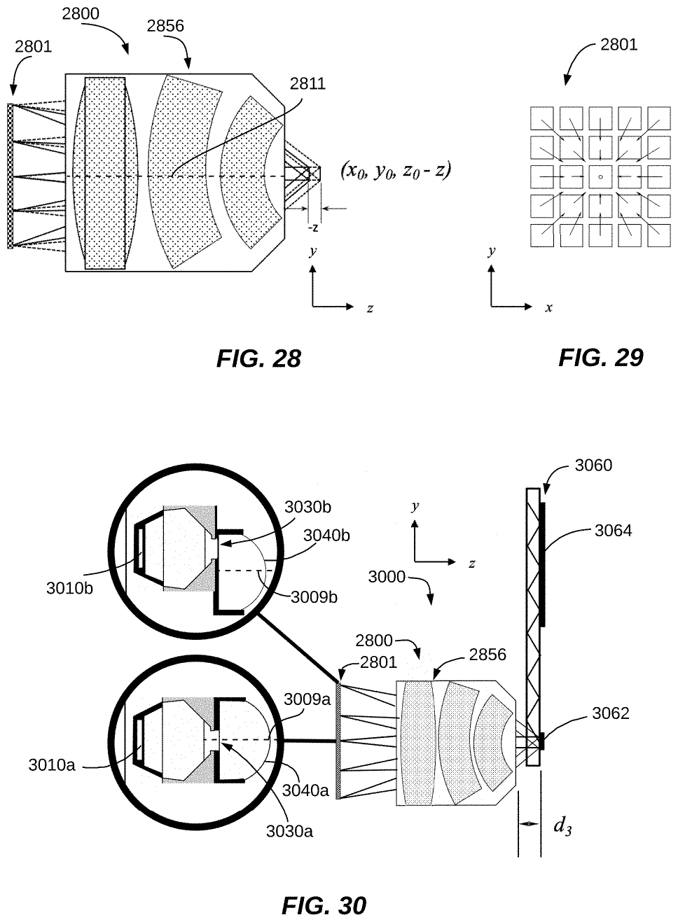

FIG. 28 illustrates an example of a convergent chief ray skew optical system 2800 having an emitter array system 2801 and a projection lens 2856. The system is considered a convergent chief ray skew because chief rays of the emitted cones of light illustrated by solid lines (where dotted lines represent uniform telecentric cones for reference) are substantially normal to the emitter array panel at the center of the emitter array panel and gradually increase in angle toward a centerline 2811 of the projector 2856 with increasing distance from the center of the emitter array panel. This concept is schematically illustrated in FIG. 29 which shows a front view of the emitter array system 2801. The lenslet array in the emitter array system emits light having chief rays that are directed in the z-direction (i.e., substantially out of the page) at the center of the array and emits light having chief rays that are most skewed toward the center of the array at the periphery of the array. Thus, the angle of the chief ray in each emitted light cone is a function of the (x, y) location of the emitter within the emitter array system 2801. The maximum chief ray angle (i.e., the chief ray angles at the periphery of the emitter array system) may determine the magnitude of the pupil location change in the −z direction. Because light at the periphery of the emitter array is angled inward toward the center, it may be possible to decrease the size of the projection lens 2856 without cutting off light and vignetting the image. Alternatively, instead of decreasing the size of the projection lens, the size of emitter array system may be increased such that more emitters and lenslets are included in the array. In this configuration, more angles of light may be fed into the projection lens 2856, thereby increasing the field of view supported by the optical system 2800.

Referring back to FIG. 28, the pupil formed at the exit of the projector lens 2856 is moved in the −z direction compared to the uniform telecentric case and has a coordinate location of (x₀, y₀, z₀−z). FIG. 30 shows a near-eye display system 3000 including the optical system 2800 described above. The system 3000 further includes a waveguide 3060 having an incoupling element 3062 and an outcoupling element 3064. The pupil formed at the exit of the projection lens 2856 is at coordinate location (x₀, y₀, z₀−z) which relates to the working distance d₃ between the projection lens exit and the pupil. The distance d₃ is less than the working distance d₁ for the uniform telecentric configuration (FIG. 23). Thus, the incoupling element 3062 configured to receive the pupil and incouple light to the waveguide 3060 may be placed closer to the exit of the projection lens 2856 when compared to the near-eye display system 2300 having a uniform telecentric emitter array system 2301.

Varied angles of chief rays across the emitter array 2801 may be achieved by varying the relative position between emitters and lenslets. For example, a center aperture 3030a and center emitter 3010a may be aligned with a center axis 3009a of the center lenslet 3040a as shown in the detailed view in the bottom left circle. The position between the emitters and lenslets at the periphery of the emitter array 2801 may be different. For example, as shown in the detailed view in the top circle of FIG. 30, a peripheral aperture 3030b and peripheral emitter 3010b may be offset by a distance relative to the center axis 3009b of the peripheral lenslet 3040b such that the center of the lenslet 3040b is closer to a center of the array system than the center of the emitter 3010b. When light from the peripheral emitter 3010b passes through the offset peripheral lenslet 3040b, it is redirected such that the chief ray of the light cone has an angle directed toward the center of the emitter array system 2801. The offset between emitters and lenslets may be incrementally increased between the center and the periphery of the emitter array system 2801 to achieve a change in the −z direction of the pupil location. While a single emitter per lenslet is shown, configurations with groups of emitters per lenslet are also possible as described with respect to FIGS. 16-22. Additionally, while lenslets 3040 are illustrated, gratings, metalenses, prisms or other micro-optics may be incorporated to alter the chief ray angles. An example of an off-axis diffraction structure 3140 is shown in FIGS. 31A and 31B where the pitch of the diffractive structure 3040 is non-uniform and diffracts the cone of light such that a chief ray is angled with respect to a normal vector 3143.

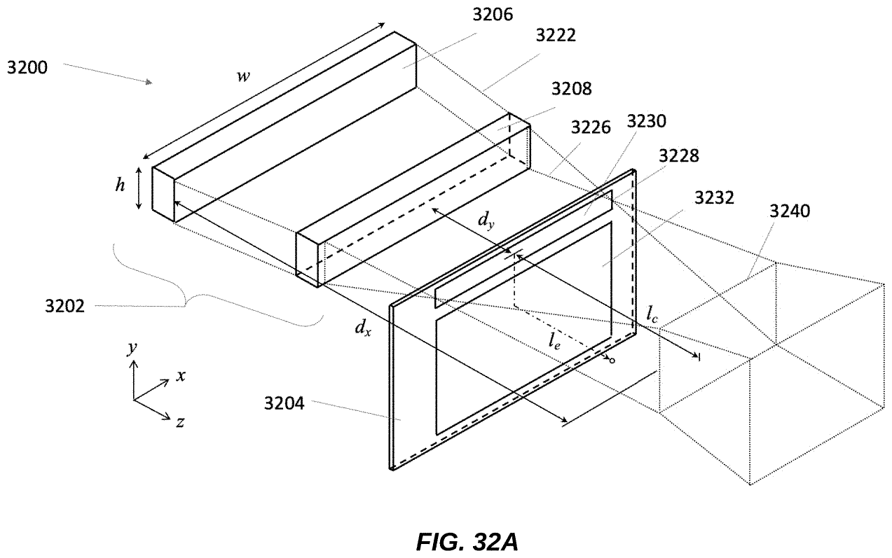

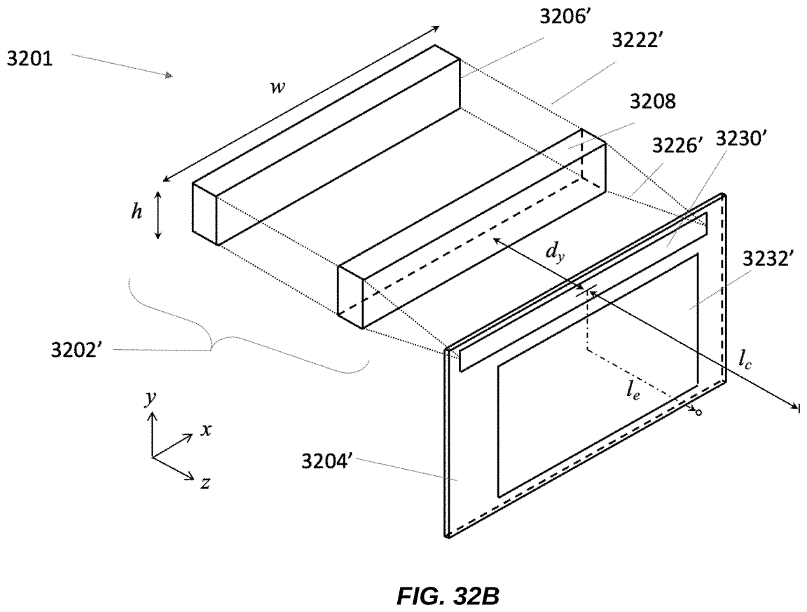

Referring to FIG. 32A, an example optical system 3200 is illustrated. The system 3200 may be considered a “split” system for transferring light from a display 3202 into an eyepiece 3204 because the directing and shaping of light occurs in multiple stages and because different optical forms are used for the two axes of optical power, as will be described in greater detail below. The display system 3202 includes an emitter array panel 3206 and a projection lens 3208. The emitter array panel 3206 may include an array of light emitters (e.g., microLEDs) and an array of lenslets (e.g., cylindrical lenslets, not shown, that may be symmetrical or asymmetrical) over the emitters. The positioning between the emitters and lenslets may be similar in some ways to the configuration discussed with respect to emitter array 2801 in the convergent chief ray skew system 2800 (FIGS. 28-30). However, the emitter array panel 3206 may differ from emitter array 2801 in a few ways. For example, rays emitted by the emitter array panel 3202 may be skewed in only one dimension (e.g., along the x-axis) rather than in two dimensions. Additionally, in some embodiments, the emitter array panel has an elongated shape (e.g., having a width dimension, w, larger than a height dimension, h). In some embodiments, the ratio of width, w, to height, h, may be approximately 4:1. In some embodiments, width, w, of the emitter array panel may be approximately 20 mm and the height, h, of the emitter array panel may be approximately 5 mm, although other dimensions and proportions are possible as a matter of design choice without departing from the scope of the present application.

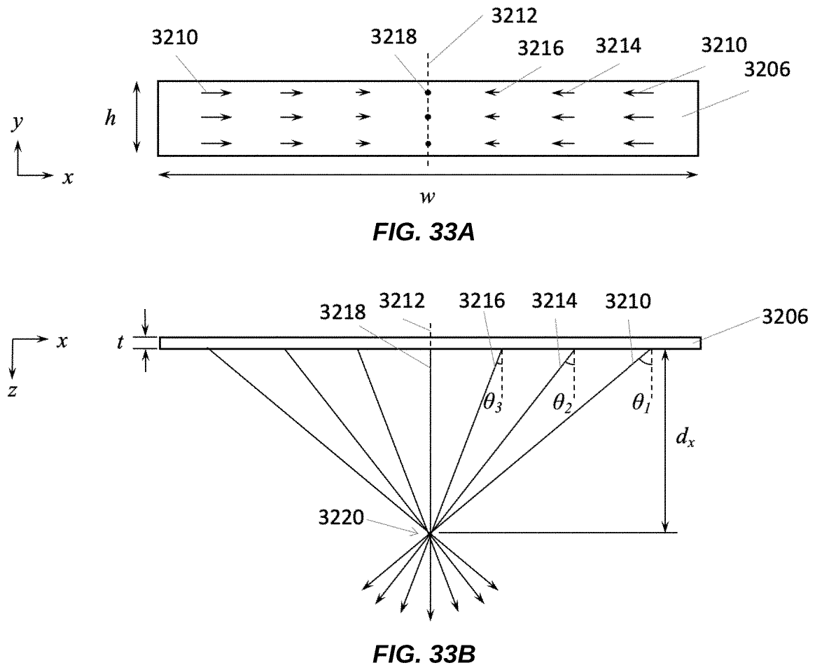

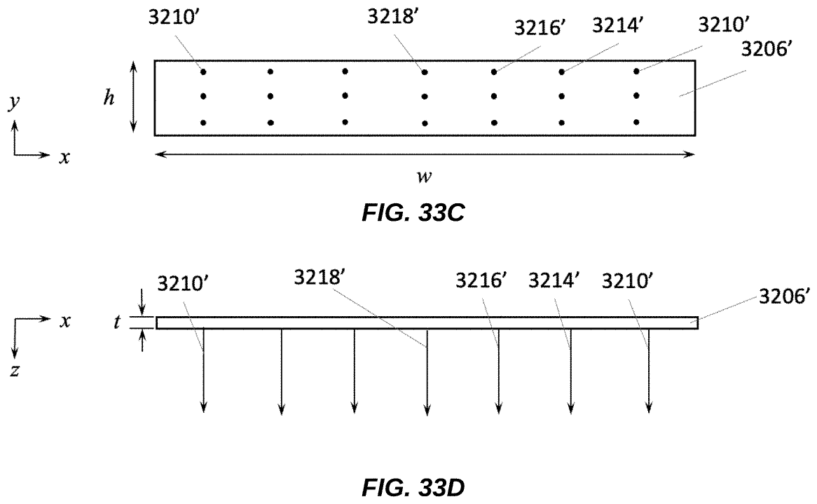

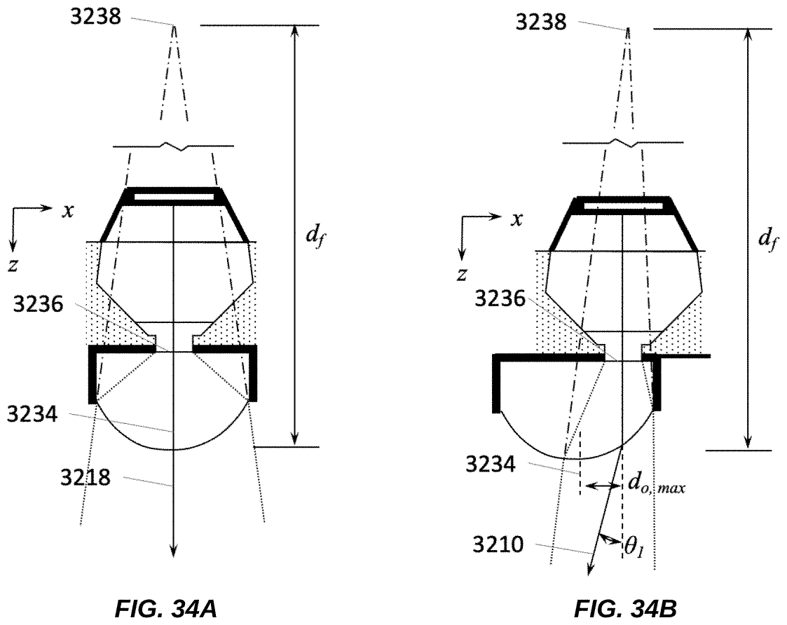

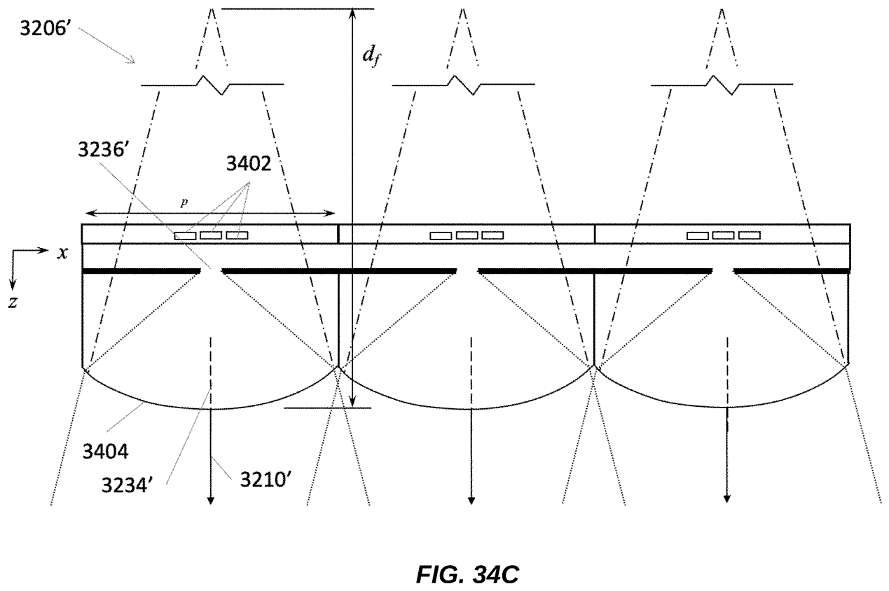

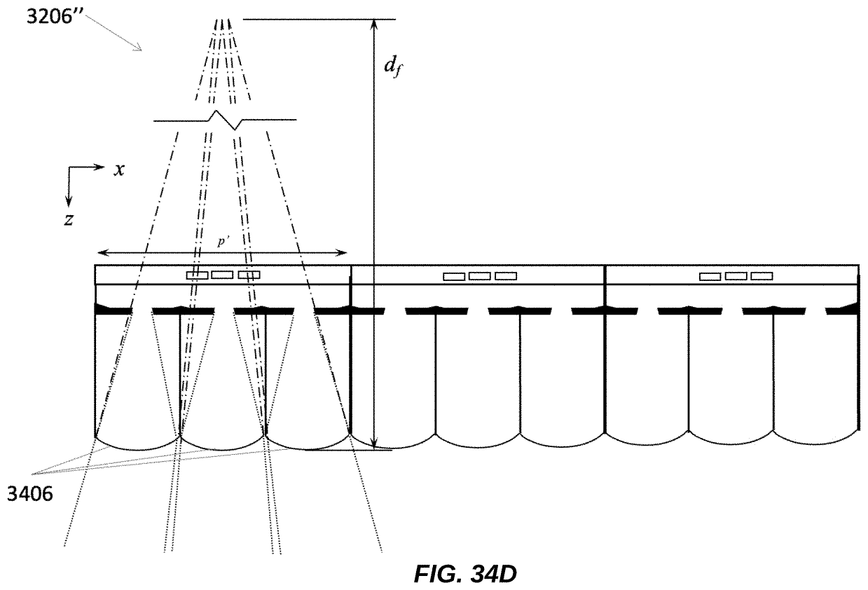

The elongated shape of emitter array panel 3206 is further illustrated in FIGS. 33A and 33B, which show front and top views, respectively, of the emitter array panel. The emitter array panel 3206 may be elongated along the same axis (e.g., the x-axis) over which rays emitted therefrom are skewed. The one-dimensional skew may be achieved by offsetting an array of cylindrical lenslets relative to underlying light emitters as illustrated in FIGS. 34A and 34B. The offset between a center axis 3234 of a cylindrical lenslet and the center axis 3236 of an underlying aperture associated with a light emitter or group of light emitters may be gradual such that the skew is minimal (e.g., approximately zero) along a centerline 3212 of the emitter array panel as shown in FIG. 34A. This allows for a chief ray 3218 emitted from center of the emitter array panel to travel substantially normal to the emitter array panel. The skew angle gradually increases along the +/−x-axis of the emitter array panel to a maximum offset, d_{o,max}, at the left and right edges of the emitter array panel as shown in FIG. 34B. Chief ray 3210 located near an edge of the emitter array panel has a maximum skew angle of θ₁ which is a function of the offset d_{o,max}. Dotted lines in FIGS. 34A and 34B represent the cone of light associated with each chief ray. Dot-dash lines illustrate the image focal point associated with the cones of light. The cone of light may be focused at a focal point 3238 located a distance, d_{f}, from the lenslet. The distance, d_{f}, is determined by the particular design of the cylindrical lenslets. The focal distance, d_{f}, may be larger than the distance between the emitter array panel 3206 and the waveguide 3204. For example, in some embodiments, the focal distance may be approximately 1 meter, though other distances may be selected as a matter of design choice without departing from the scope of the present application. In an example, at least a portion of the cylindrical lenslets form an image of at least a portion of emitters within the emitter array at a distance between approximately 500 millimeters and infinity.

The one-dimensional skew of chief rays is also illustrated in FIGS. 33A and 33B, where the arrows represent chief rays emitted by light emitters and directed by cylindrical lenses within the emitter array panel. The chief rays 3210 furthest from a centerline 3212 of the emitter array panel 3206 are angled toward the centerline 3212 at a first angle θ₁ measured from a line normal to a front surface of the emitter array panel (e.g., a front surface of a cylindrical lenslet). The first angle θ₁ may be larger than second and third angles θ₂ and θ₃ that are associated with rays 3214, 3216, respectively. Rays 3214 and 3216 originate from positions nearer to the centerline 3212 in the x-direction than ray 3210. A chief ray 3218 emitted from a location substantially on the centerline 3212 may have a trajectory substantially parallel to the line normal to the front surface of the emitter array panel, and therefore, has approximately zero skew. In some embodiments, all chief rays emitted from the emitter array panel 3206 are directed toward an x-direction focal point 3220 located at a distance, dx, from the front surface of the emitter array panel. However, each chief ray represents a cone of light (FIGS. 34A, 34B) focused at a non-infinite distance (e.g., approximately 1 meter or more away from a viewing location where a user's eye is located). Thus, the light at distance dx may form a broader beam waist 3240 (FIG. 32) instead of a small focal point.

Referring back to FIG. 32A, dashed lines extending from the emitter array panel 3206 represent a group of rays 3222 emitted by emitter array panel 3206 (e.g., chief rays 3210, 3214, 3216, 3218 and associated cones of light) that are inwardly angled by an amount varying with position of the emitter along the x-axis, as discussed with respect to FIGS. 33A-34B. The trajectory of light rays does not vary along the y-dimension of the emitter array panel. Rays originating from emitters sharing a common x-coordinate on the emitter array panel but having different y-coordinates may follow substantially parallel trajectories. Thus, light emitted from the emitter array panel would not converge to a focal point in the y-dimension without the use of projection lens 3208.

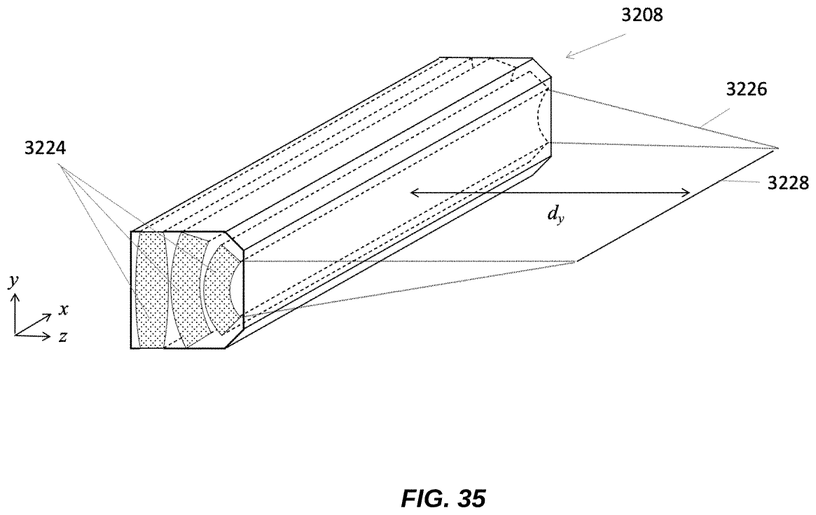

Light rays 3222 from the emitter array panel impinge on the projection lens 3208. An example of a projection lens 3208 component is illustrated in detail in FIG. 35. The projection lens may include one or more optical elements, such as lenses 3224. Each lens 3224 may have a shape that is different from or the same as other lenses in the projection lens. In some embodiments, the lenses may be cylindrical or toroidal lenses such that a cross-sectional shape taken in the y-z-plane remains constant over the x-dimension while a cross-sectional shape taken in the x-z-plane varies along the y-dimension. The projection lens may not have any optical power along the x-axis. Thus, a trajectory of the light rays 3222 entering the projection lens 3208 may be altered as a function of the y-coordinate location at which each ray enters the optics 3208. In some embodiments, the projection lens 3208 may act to collimate light cones in they-direction and converge the chief rays in they-direction at ay-direction focal point (or focal line) 3228 located at a distance, d_{y}, from the projection lens component. In some embodiments, light rays may converge in the y-direction at a location that is different from the location at which the light rays converge, or form a beam waist, in the x-direction. In the example system illustrated in FIG. 32, convergence in the y-direction occurs at a point along the light path nearer to the emitter array panel than convergence in the x-direction.

Chief rays exiting the projection lens 3208, represented by dotted lines 3226, are on a converging trajectory in both the x- and y-directions as they impinge on an incoupling optical element 3230 disposed on or within the waveguide 3204. The light cones associated with each chief ray are collimated in the y-direction and are focused at some long distance, d_{f}, in the x-direction. Spacing between the emitter array panel, shaping optics, and incoupling optical element, as well as the light path angles created at the emitter array panel and projection lens, may be selected such that light rays 3226 impinge on the incoupling optical element 3230 at the y-direction convergence location 3228 and before the x-direction convergence location. Once the light rays incouple into the waveguide via the incoupling optical element, at least a portion of the light is diffracted and/or reflected within the waveguide 3204 (e.g., by total internal reflection “TIR”) and reaches an outcoupling optical element 3232. The light path of light within the waveguide 3204 is represented by the dot-dashed line between the incoupling optical element 3230 and the outcoupling optical element 3232. The outcoupling optical element redirects the light as the light travels in the −y-dimension and interacts with the outcoupling optical element 3232 such that a portion of the light exits the waveguide 3204 toward a user's eye (as represented by the dot-dashed arrow pointing away from the outcoupling optical element 3232) while the remaining portion continues to travel in the −y-dimension. Thus, the outcoupling optical element 3232 replicates the pupil formed at 3228 and expands an eyebox (e.g., a region in which a viewer's eye may observe the image represented by light exiting the outcoupling optical element) in the y-dimension. The length of the path of light from the incoupling optical element to the eye of the viewer is represented as the two dot-dashed lines and is labeled lₑ. In some embodiments, the distance lₑ is substantially the same as a distance l_{c}, where the distance l_{c} is the distance between the incoupling optical element of the waveguide 3204 and the beam waist 3240. Thus, as light travels through the waveguide 3204, it continues to converge and focus such that the beam waist location is coincident with the viewer's eye location.

Another embodiment of an optical system 3201 is illustrated in FIG. 32B. Similar to the system 3200, the system 3201 may be considered a “split” system for transferring light from a display 3202′ into an eyepiece 3204′. The display system 3202′ includes an emitter array panel 3206′ and a projection lens 3208. The emitter array panel 3206′ may include an array of light emitters (e.g., microLEDs) and an array of lenslets (e.g., cylindrical lenslets, not shown, that may be symmetrical or asymmetrical) disposed over the emitters. Positioning between the array of light emitters and the array of lenslets is such that light exiting the lenslets toward the projection lens 3208′ is not skewed along the x-direction. Thus, the light does not converge in the x-dimension. This is illustrated in front and top views, respectively, of the emitter array panel 3206′ shown in FIGS. 33C and 33D. Chief rays 3210′, 3214′, 3216′, 3218′ exiting the emitter array panel 3206′ are substantially parallel to each other in both x- and y-dimensions. The relationship between the emitter array, apertures, and lenslet array may constant across the entire emitter array panel 3206′ and may be similar to the relationship illustrated in FIG. 34A.

Other configurations of the emitter array panel 3206′ are possible. For example, referring initially to FIG. 34C, a plurality of microLED emitters 3402 may be associated with a single aperture 3236′ and a single lenslet 3404. The lenslet 3404 may be positioned such that a centerline 3234′ of the lenslet aligns with a center of the aperture 3236′ in the x-dimension. A chief ray (e.g., ray 3210′) may be emitted from the lenslet at an angle substantially normal to the emitter array panel 3206′. A cone of light associated with each chief ray, as illustrated by dotted lines, may also be emitted and may be shaped by the lenslet 3404 such that a focal point is created at a distance d_{f} from the lenslet, as illustrated by dot-dashed lines. In some embodiments, the distance d_{f} may be approximately 1 meter, but other distances are possible as a function of the lenslet design. Furthermore, the chief rays may travel in a direction substantially normal to a front surface of the emitter array panel 3206′. The plurality of emitters 3402 may be disposed within the emitter array panel at a pitch, p, and the pitch may be approximately 25 μm. A width dimension of the lenslets 3404 may be approximately equal to pitch, p.

Referring now to FIG. 34D, another embodiment of an emitter array panel 3206″ is illustrated. A plurality of microLED emitters 3402 may be associated with a plurality of apertures 3236″ and each of the plurality of apertures 3236″ may be associated with a single lenslet 3406. The lenslets 3406 may be positioned such that a centerline 3234″ of each lenslet 3406 aligns with a center of the aperture 3236″ in the x-dimension. Chief rays may be emitted from each lenslet 3406 at a different angle. In the illustrated embodiment, where three lenslets are shown, light passing through the center lenslet may have a chief ray directed substantially normal to the emitter array panel 3206″. Lenslets to the left and right of the center lenslet may have chief rays that are angled away from the center lenslet. Each lenslet emits a cone of light, represented by dotted lines, that is shaped such that focal points are formed at a distance, d_{f}, from the lenslet. Because a plurality of apertures and a plurality of lenslets are used to shape and direct light from the microLED emitters, a plurality of focal points are formed. In some embodiments, the pitch, p′, of the microLED array may be approximately 25 μm. The width dimension of the plurality of lenslets associated with each group of microLED emitters may be equal to pitch, p. Thus, compared to the lenslets 3404 in system 3206′, lenslets 3406 may have a smaller width. The lenslets 3406 having smaller width may provide a higher fidelity pixel image than a single larger lenslet 3404.

Once the light from the emitter array system, represented by dotted lines 3222′, 3206′ reaches the projector lens 3208, the projector lens 3208 may act to converge and/or collimate the light in they-dimension as represented by dotted lines 3226′. The light may reach a y-dimension focal point at a distance, d_{y}, from the projection lens. A waveguide eyepiece 3204′ may be placed such that an incoupling optical element 3228′ is located at the focal point and light is then incoupled to the eyepiece. Light incoupled into the eyepiece diffracts and/or reflects within the eyepiece along a −y-dimension such that it encounters an outcoupling optical element 3232′. As the light interacts with the outcoupling optical element 3232′ and travels in the −y-dimension, a plurality of pupils of light will exit the waveguide 3204′, thereby forming an eyebox wherein a viewer may observe an image represented by the light.

The systems 3200 and 3201 provide several advantages. In particular, the split system enables a practical form factor for a minimized, brow-mounted display and projector. Such a form factor may be easily integrated into a pair of glasses near the eyebrow of the user without requiring bulky frames. Additionally, the system 3200 includes a large ICG that is configured to incouple a high amount of light from the display and projector. Incoupling such a large amount of light results in improved brightness and efficiency of the image exiting the outcoupling optical element for viewing by a user. Furthermore, because of elongated shape of the emitter array panel, projector, and incoupling optical element, the eyepiece needs only replicate the light pupil in one direction (e.g., the y-direction). Reducing the requirements of the outcoupling optical element improves efficiency of the waveguide eyepiece and simplifies optical design and fabrication demands.

Accordingly, although the present disclosure has been provided in accordance with the implementations shown, one of ordinary skill in the art will readily recognize that there could be variations to the embodiments and those variations would be within the scope of the present disclosure. Therefore, many modifications may be made by one of ordinary skill in the art without departing from the scope of the appended claims.

1. An optical system comprising:
a display system comprising:
an emitter array panel having an emitter array and a lenslet array, wherein the lenslet array comprises cylindrical lenslets having optical power along a first axis; and
a projection lens having optical power along a second axis substantially perpendicular to the first axis; and
a pupil-replicating waveguide having an incoupling optical element and an outcoupling optical element.

2. The optical system of claim 1, wherein the emitter array comprises a plurality of microLED emitters.

3. The optical system of claim 2, wherein at least a portion of the cylindrical lenslets form an image of at least a portion of emitters within the emitter array at a distance between approximately 500 millimeters and infinity.

4. The optical system of claim 2, wherein a plurality of microLED emitters are grouped together to form a pixel within the emitter array panel.

5. The optical system of claim 4, wherein the pixels are disposed at a pitch over an area of the emitter array panel.

6. The optical system of claim 5, wherein the pitch is approximately 25 μm.

7. The optical system of claim 1, wherein the cylindrical lenslets are configured to focus, via optical power along the first axis, light from the emitter array at a first focal point that is at a first focal distance, and wherein the first focal distance is non-infinite.

8. The optical system of claim 7, wherein the first focal distance is approximately 1 meter.

9. The optical system of claim 1, wherein the projection lens is configured to collimate, via optical power along the second axis, light from the lenslet array.

10. The optical system of claim 9, wherein the projection lens is further configured to converge the collimated light at a pupil location.

11. The optical system of claim 10, wherein the incoupling optical element is positioned at the pupil location.

12. The system of claim 7, wherein the first focal distance is approximately equal to a light path distance of light reflecting through the waveguide toward a user's eye.

13. The system of claim 1, wherein the incoupling optical element is elongated.

14. The system of claim 1, wherein the outcoupling optical element is configured to replicate exit beams along a single axis.

15. The system of claim 7, wherein the projection lens is configured to focus, via optical power along the second axis, light from the lenslet array at a second focal point a second focal distance from the projection lens.

16. The system of claim 15, wherein the first focal point and the second focal point are located at substantially the same position.
